(19) United States
(12) Patent Application Publication
(10) Pub. No.: US 2023/0089078 A1
(43) Pub. Date: Mar. 23, 2023

(54) POLYESTER RESIN AND PRODUCTION METHOD THEREFOR

(71) Applicants: UNITIKA LTD., Osaka (JP); NIPPON ESTER CO., LTD., Aichi (JP)

(72) Inventors: Yumeto Fukubayashi, Aichi (JP); Yuta Tenma, Aichi (JP)

(73) Assignees: UNITIKA LTD., Osaka (JP); NIPPON ESTER CO., LTD., Aichi (JP)

(21) Appl. No.: 17/800,583

(22) PCT Filed: Feb. 24, 2021
(86) PCT No.: PCT/JP2021/006726

§ 371 Date: Aug. 18, 2022

(30) Foreign Application Priority Data
Feb. 27, 2020 (JP) 2020-031370

(51) Int. Cl. C08G 63/87; C09J 167/02

(52) U.S. Cl. CPC C08G 63/87; C09J 167/02

(57) ABSTRACT

A polyester resin comprises a dicarboxylic acid component and a glycol component, wherein the glycol component contains ethylene glycol together with diethylene glycol and triethylene glycol, and a content of triethylene glycol in the glycol component is more than 0.1 mol % and 5.5 mol % or less.

### TECHNICAL FIELD

The present invention relates to a polyester resin and a method for producing the same.

### BACKGROUND ART

Polyester resins typified by polyethylene terephthalate (PET), polybutylene terephthalate (PBT), and polyethylene naphthalate (PEN) are excellent in mechanical properties and chemical properties, being used in a wide range of fields such as fibers for clothing and industrial materials, films or sheets for packaging and magnetic tapes, bottles as hollow molded articles, casings for electrical and electronic parts, and other engineering plastic molded articles.

Conventionally, in the production of polyester resins, a metal-based catalyst such as an antimony-based or germanium-based catalyst has been used as a polycondensation catalyst at the time of solid-phase polycondensation.

Although an antimony-based catalyst is inexpensive and excellent in catalytic activity, metal antimony may precipitate during polycondensation when used in an amount sufficient to exhibit a practical polymerization rate. Therefore, darkening or a foreign substance occurs in the produced polyester resin, which causes surface defects of a processed product. Further, it is difficult to obtain a hollow molded article having excellent transparency.

On the other hand, a germanium-based catalyst is very expensive, and easily distilled away out of the reaction system during polymerization to cause change in the catalyst concentration in the system, resulting in a problem of difficulty in polymerization control.

Accordingly, polycondensation catalysts that replace antimony-based or germanium-based catalysts have been studied, and titanium compounds such as tetraalkoxy titanate have been proposed. However, polyesters produced using the catalysts are susceptible to thermal deterioration during melt molding, having a problem of being easily colored.

Organic catalysts as replacement for metal-based catalysts have been also studied, and for example, sulfonic acid-based compounds such as p-toluenesulfonic acid have been proposed (for example, Patent Literature 1). Sulfonic acid-based compounds have excellent polymerization activity, and polyesters produced therefrom have a good color tone.

### CITATION LIST

### Patent Literature

Patent Literature 1: Japanese Patent Publication No. 63-033489

### SUMMARY OF INVENTION

### Technical Problem

In recent years, a polyester resin having further improved mechanical properties when formed into a molded body has been desired.

An object of the present invention is to provide a polyester resin having excellent transparency and mechanical properties when formed into a molded body.

### Solution to Problem

As a result of extensive studies to solve the problems, the present inventors have found that a molded body produced from a polyester resin containing ethylene glycol together with diethylene glycol and triethylene glycol as glycol component, having a triethylene glycol content in a specific range, has excellent transparency and mechanical properties, and have reached the present invention.

A polyester resin of the present invention includes a dicarboxylic acid component and a glycol component,

wherein the glycol component contains ethylene glycol together with diethylene glycol and triethylene glycol, and

a content of triethylene glycol in the glycol component is more than 0.1 mol % and 5.5 mol % or less.

According to the polyester resin of the present invention, it is preferable that a content of diethylene glycol in the glycol component be 2.5 mol % or more.

According to the polyester resin of the present invention, it is preferable that the glycol component contain tetraethylene glycol, and a content of tetraethylene glycol in the glycol component be 2.0 mol % or less.

According to the polyester resin of the present invention, it is preferable that a sum of the content of triethylene glycol and the content of tetraethylene glycol in the glycol component be 7.0 mol % or less.

According to the polyester resin of the present invention, it is preferable that a content of a metal component derived from catalyst be 1 ppm or less.

According to the polyester resin of the present invention, it is preferable that a content of a sulfur component be 1 to 500 ppm.

According to the polyester resin of the present invention, it is preferable that the dicarboxylic acid component include terephthalic acid as a main component.

According to the polyester resin of the present invention, it is preferable that a molded body having a thickness of 2 mm have a haze of 5% or less.

A molded body of the present invention is made of the polyester resin.

A fiber of the present invention is made of the polyester resin.

A film of the present invention is made of the polyester resin.

An adhesive of the present invention includes the polyester resin.

A resin solution of the present invention contains the polyester resin and a solvent.

A method for producing a polyester resin of the present invention is a method for producing the polyester resin including adding an organic sulfonic acid-based compound to a raw material polyester resin, and heating the mixture at a temperature of 240° C. or more under normal pressure or increased pressure for 5 to 120 minutes to perform an etherification reaction of the glycol component.

In the method for producing a polyester resin of the present invention, it is preferable that the organic sulfonic acid-based compound be at least one or more selected from the group consisting of 2-sulfobenzoic acid anhydride, o-sulfobenzoic acid, m-sulfobenzoic acid, p-sulfobenzoic acid, 5-sulfosalicylic acid, benzenesulfonic acid, o-aminobenzenesulfonic acid, m-aminobenzenesulfonic acid, p-aminobenzenesulfonic acid, p-toluenesulfonic acid, methyl p-toluenesulfonate, 5-sulfoisophthalic acid, and salts thereof.

### Advantageous Effects of Invention

The polyester resin of the present invention is excellent in transparency and mechanical properties such as rapture elongation when formed into a molded body.

### DESCRIPTION OF EMBODIMENTS

Hereinafter, the polyester resin of the present invention will be described in detail.

The polyester resin of the present invention is a polyester resin containing a dicarboxylic acid component and a glycol component.

### Glycol Component

It is required that the glycol component constituting the polyester resin of the present invention contains ethylene glycol together with diethylene glycol and triethylene glycol, and a content of triethylene glycol in the glycol component is more than 0.1 mol % and 5.5 mol % or less.

Due to the glycol component simultaneously containing ethylene glycol, diethylene glycol and a predetermined amount of triethylene glycol, the polyester resin of the present invention allows to produce a molded body having excellent mechanical properties.

In the polyester resin of the present invention, it is required that a content of triethylene glycol in the glycol component is more than 0.1 mol % and 5.5 mol % or less, preferably 0.2 to 4.0 mol %. With a triethylene glycol content of 0.1 mol % or less, the polyester resin has insufficient effect of improving mechanical properties, while with a content of more than 5.5 mol % thermal properties and weather resistance decrease.

In the polyester resin of the present invention, a content of ethylene glycol content in the glycol component is preferably 20 mol % or more, and more preferably ethylene glycol is a main glycol component. In other words, the content of ethylene glycol in the glycol component is more preferably 50 mol % or more, still more preferably 70 mol % or more, and particularly preferably 80 mol % or more. With an ethylene glycol content of 20 mol % or more, the polyester resin allows to produce a molded body having superior mechanical properties.

In the polyester resin of the present invention, a content of diethylene glycol in the glycol component is preferably 2.5 mol % or more, more preferably 3.0 mol % or more, and still more preferably 5 mol % or more, and particularly preferably 10 mol % or more. With a diethylene glycol content in the range, the polyester resin can have further improved mechanical properties. It is preferable that an upper limit of the content of diethylene glycol in the glycol component be 30 mol %.

Further, in the polyester resin of the present invention, the sum of the content of diethylene glycol and the content of triethylene glycol in the glycol component is preferably more than 2.6 mol % more preferably more than 2.6 mol % and 35 mol % or less, and still more preferably 3.2 to 34 mol %.

In the polyester resin of the present invention, it is preferable that the glycol component contain tetraethylene glycol, and the content of tetraethylene glycol is preferably 2.0 mol % or less, more preferably 0.1 to 0.5 mol %. With a content of tetraethylene glycol in the glycol component of more than 2.0 mol %, the polyester resin may have decreased thermal characteristics and weather resistance.

In the polyester resin of the present invention, the sum of the content of triethylene glycol and the content of tetraethylene glycol in the glycol component is preferably 7.0 mol % or less, more preferably 0.2 to 7.0 mol %, and still more preferably 0.4 to 6.0 mol %. With a sum of the content of triethylene glycol and the content of tetraethylene glycol in the glycol component of more than 7.0 mol %, the polyester resin may have poor mechanical properties.

The polyester resin of the present invention having a glycol component including ethylene glycol, with a diethylene glycol content, a triethylene glycol content, a tetraethylene glycol content, and a total content of diethylene glycol and triethylene glycol or total content of triethylene glycol and tetraethylene glycol in the glycol component controlled in the range allows to produce a molded body having further improved mechanical properties.

Examples of the method for simultaneously containing diethylene glycol and triethylene glycol in the glycol component, and controlling the respective contents of triethylene glycol, diethylene glycol, and tetraethylene glycol, the total content of diethylene glycol and triethylene glycol, and the total content of triethylene glycol and tetraethylene glycol in the ranges in the polyester resins of the present invention include a method for performing an etherification reaction of the glycol component using an organic sulfonic acid-based compound as polymerization catalyst at a specific temperature and time, in a production method of polyester resins described later.

The polyester resin of the present invention contains ethylene glycol together with diethylene glycol and triethylene glycol, preferably with tetraethylene glycol, and may further contain another glycol component. Specific examples thereof include an aliphatic glycol such as 1,2-propylene glycol, 1,3-propylene glycol, 1,2-butylene glycol, 1,3-butylene glycol, 2,3-butylene glycol, 1,4-butylene glycol, 1, 5-pentanediol, 3-methyl-1,5-pentanediol, neopentyl glycol, 1,6-hexanediol, 1,2-cyclohexanediol, 1,3-cyclohexanediol, 1,4-cyclohexanediol, 1,2-cyclohexanedimethanol, 1,3-cyclohexanedimethanol, 1,4-cyclohexanedimethanol, 1,4-cyclohexanediethanol, 1,10-decamethylene glycol and 1,12-dodecanediol, and an aromatic glycol such as hydroquinone, 4,4′-dihydroxybisphenol, 1,4-bis((β-hydroxyethoxy)benzene, 1,4-bis(β-hydroxyethoxyphenyl)sulfone, bis(p-hydroxyphenyl)ether, bis(p-hydroxyphenyl)sulfone, bis(p-hydroxyphenyl)methane, 1,2-bis(p-hydroxyphenyl)ethane, bisphenol A, bisphenol C, 2,5-naphthalenediol, and ethylene oxide adducts of the glycols. In particular, 1,3-propylene glycol, 1,4-butylene glycol, and 1,4-cyclohexanedimethanol are preferred.

From the viewpoint of excellence in flexibility, in particular, it is preferable that in the polyester resin of the present invention, the glycol component contain 1,4-cyclohexanedimethanol, at a content in the glycol component of more preferably 1.0 to 50.0 mol %, still more preferably, 2.0 to 20.0 mol %. Further, from the viewpoint of excellence in mechanical properties, it is preferable to contain an ethylene oxide adduct of bisphenol A at a content in the glycol component of more preferably 1.0 to 30.0 mol %, still more preferably 2.0 to 20 mol %.

From the viewpoint of excellence in durability, it is preferable to contain neopentyl glycol at a content in the glycol component of more preferably 1.0 to 50.0 mol %, still more preferably 2.0 to 20.0 mol %. Further, from the viewpoint of excellence in compatibility and transparency, it is preferable to contain 3-methyl-1,5-pentanediol at a content in the glycol component of more preferably 1.0 to 50.0 mol %, and still more preferably 2.0 to 20.0 mol %. Further, from the viewpoint of excellence in mechanical properties, it is preferable to contain 1,4-butylene glycol at a content in the glycol component of more preferably 1.0 to 80.0 %, still more preferably 2.0 to 70.0 mol %. In particular, a polyester resin containing 1,4-butylene glycol is preferable for use in laminated bottles.

### Dicarboxylic Acid Component

Examples of the dicarboxylic acid component constituting the polyester resin of the present invention include a saturated aliphatic dicarboxylic acid such as oxalic acid, malonic acid, succinic acid, glutaric acid, adipic acid, pimelic acid, suberic acid, azelaic acid, sebacic acid, decanedicarboxylic acid, dodecanedicarboxylic acid, tetradecanedicarboxylic acid, hexadecanedicarboxylic acid, 1,3-cyclobutanedicarboxylic acid, 1,3-cyclopentanedicarboxylic acid, 1,2-cyclohexanedicarboxylic acid, 1,3-cyclohexanedicarboxylic acid, 1,4-cyclohexanedicarboxylic acid, 2,5-norbornanedicarboxylic acid, and dimeric acid, or an ester-forming derivative thereof; and an unsaturated aliphatic dicarboxylic acid such as fumaric acid, maleic acid, and itaconic acid, or an ester-forming derivative thereof; and an aromatic dicarboxylic acid such as orthophthalic acid, isophthalic acid, terephthalic acid, 5-(alkali metal)sulfoisophthalic acid, diphenylic acid, 1,3-naphthalenedicarboxylic acid, 1,4-naphthalenedicarboxylic acid, 1,5-naphthalenedicarboxylic acid, 2,6-naphthalenedicarboxylic acid, 2,7-naphthalenedicarboxylic acid, 4,4′-biphenyldicarboxylic acid, 4,4′-biphenylsulfonedicarboxylic acid, 4,4′-acid, 1,2-bis(phenoxy)ethane-p,p′-dicarboxylic acid, pamoic acid, and anthracenedicarboxylic acid, or an ester-forming derivative thereof; which may be used in combination. In particular, terephthalic acid and naphthalenedicarboxylic acid (particularly 2,6-naphthalenedicarboxylic acid) are preferred in terms of resin properties and versatility, and terephthalic acid is more preferred.

The polyester resin of the present invention may contain a polyvalent carboxylic acid component other than the dicarboxylic acid component and a hydroxycarboxylic acid component.

### Polyvalent Carboxylic Acid Component

Examples of the polyvalent carboxylic acid component other than the dicarboxylic acid component include ethanetricarboxylic acid, propanetricarboxylic acid, butanetetracarboxylic acid, pyromellitic acid, trimellitic acid, trimesic acid, 3,4,3′,4′-biphenyltetracarboxylic acid, and an ester-forming derivative thereof.

### Hydroxycarboxylic Acid Component

Examples of the hydroxycarboxylic acid component include lactic acid, citric acid, malic acid, tartaric acid, hydroxyacetic acid, 3-hydroxybutyric acid, p-hydroxybenzoic acid, p-(2-hydroxyethoxy)benzoic acid, and 4-hydroxycyclohexanecarboxylic acid, or an ester-forming derivative thereof; and a cyclic ester such as ε-caprolactone, β-propiolactone, β-methyl-β-propiolactone, δ-valerolactone, glycolide, and lactide. In particular, it is preferable that the cyclic ester contain ε-caprolactone at a content of 1.0 to 50.0 mol % in the polyester resin.

Examples of the ester-forming derivative of the polyvalent carboxylic acid and the hydroxycarboxylic acid include an alkyl ester, an acid chloride, an acid anhydride thereof.

Examples of the polyester made of the parts include a copolymer such as polyethylene terephthalate, polybutylene terephthalate, polypropylene terephthalate, poly(1,4-cyclohexanedimethylene terephthalate), polyethylene naphthalate, polybutylene naphthalate, and polypropylene naphthalate. From the viewpoint of resin properties and versatility, it is preferable to use an ethylene terephthalate unit as main repeating unit, though other parts may be copolymerized as described above.

### Haze

The polyester resin containing the parts of the present invention has excellent transparency after forming, and the measured haze of a molded body having a thickness of 2 mm is preferably 5% or less, more preferably 2% or less, and still more preferably 1% or less.

### Mechanical Properties

Further, a molded body produced from the polyester resin containing the parts of the present invention is excellent in mechanical properties such as tensile properties, and the tensile rapture elongation is preferably 70% or more, more preferably 100% or more, still more preferably 180% or more, and particularly preferably 200% or more.

### Limiting Viscosity

The polyester resin of the present invention has a limiting viscosity of preferably 0.45 dl/g or more, more preferably 0.5 dl/g or more, and still more preferably 0.6 to 0.8 dl/g. With a limiting viscosity of less than 0.45 dl/g, a molded body produced from the polyester resin may have insufficient mechanical properties.

### Additive

To the polyester resin of the present invention, an optional polymer, an antistatic agent, an antifoaming agent, an dyeing improver, a dye, a pigment, a matting agent, a fluorescent whitening agent, a stabilizer, an antioxidant, a colorant, a flame retardant and other additives may be added in a range not impairing the effect of the present invention. Examples of the antioxidant include an aromatic amine-based and phenol-based antioxidants. Examples of the stabilizer include a phosphorus-based stabilizer such as a phosphoric acid or phosphoric acid ester-based stabilizer, a sulfur-based stabilizer, and an amine-based stabilizer.

To the polyester resin of the present invention, an organic, inorganic or organometallic toner, or a fluorescent whitening agent may be added in a range not impairing the effects of the present invention. Thereby, coloring such as yellowing of the polyester resin may be further suppressed. Alternatively, in order to improve the crystallinity, mixing with another resin such as polyethylene or an inorganic nucleating agent such as talc may be performed.

To the polyester resin of the present invention, a cobalt compound may be added for the purpose of improving color tone, in a range not impairing the effects of the present invention. The cobalt compound is not particularly limited, and specific examples thereof include cobalt acetate, cobalt nitrate, cobalt chloride, cobalt acetylacetonate, cobalt naphthenate, and hydrates thereof. In particular, cobalt acetate tetrahydrate is preferred. The amount of the cobalt compound added is preferably 10 ppm or less, more preferably 5 ppm or less, and still more preferably 3 ppm or less, in terms of cobalt atom relative to the polyester resin.

Even mixing of the polyester resin of the present invention with a waste resin generated in a production process or a recycled polyester resin or the like recovered from the market (for example, PET bottles) allows to obtain a high-quality molded body that is hard to deteriorate.

### Method for Producing Polyester Resin

The method for producing a polyester resin of the present invention includes adding an organic sulfonic acid-based compound to a raw material polyester resin, and heating the mixture at a temperature of 240° C. or more under normal pressure or increased pressure for 5 to 120 minutes to perform an etherification reaction of the glycol component.

In the present invention, by including performing an etherification reaction under specific conditions before performing a polycondensation reaction, diethylene glycol and triethylene glycol are simultaneously contained, and the content of triethylene glycol is controlled to the range. Further, the content of diethylene glycol, the content of tetraethylene glycol, and the content of triethylene glycol and tetraethylene glycol are controlled to preferable ranges. As a result, a polyester resin excellent in transparency and mechanical properties such as rapture elongation when formed into a molded body can be obtained.

### Raw Material

Examples of the raw material of the polyester resin include a glycol component containing ethylene glycol, a dicarboxylic acid component, and an esterified product as a low-order condensate composed of a glycol component and a dicarboxylic acid component.

A method for obtaining the esterified product, for example, in the case of producing polyethylene terephthalate as a polyester resin, is as follows. Terephthalic acid, ethylene glycol, and, on an as needed basis, other copolymerization parts are directly reacted to distill off water, and through esterification, an esterified product as raw material for the polyester resin is obtained. Alternatively, dimethyl terephthalate, ethylene glycol, and, on an as needed basis, other copolymerization parts are reacted to distill off methyl alcohol, and through transesterification, an esterified product is obtained. The esterification reaction and the transesterification reaction may be performed in one stage or may be performed in separate multiple stages.

Hereinafter, the method for preparing the esterified product will be specifically described.

A slurry containing ethylene glycol in an amount of preferably 1.02 to 2.5 mol, more preferably 1.03 to 1.8 mol, relative to 1 mol of dicarboxylic acid or ester derivative thereof, is prepared, and continuously supplied into an esterification reactor to obtain an esterified product.

The esterification reaction is performed, for example, under conditions for refluxing ethylene glycol in a multi-stage apparatus having 1 to 3 esterification reactors connected in series, while removing water or alcohol produced by the reaction from the system at a rectifying column.

The temperature of the esterification reaction in the first stage is preferably 240 to 270° C., more preferably 245 to 265° C. The pressure is preferably 0.2 to 3 kg/cm²G, more preferably 0.5 to 2 kg/cm²G.

The temperature of the esterification reaction in the final stage is preferably 250 to 290° C., more preferably 255 to 275° C. The pressure is preferably 0 to 1.5 kg/cm²G, more preferably 0 to 1.3 kg/cm²G.

In the case where the esterification reaction is performed in three or more stages, the reaction conditions for the esterification reaction in an intermediate stage are preferably conditions between the reaction conditions in the first stage and the reaction conditions in the final stage.

It is preferable that the reaction rate of the esterification reaction in multiple stages be smoothly increased in each stage. Finally, the esterification reaction rate reaches preferably 90% or more, more preferably 93% or more. Through these esterification reactions, an esterified product can be obtained, and the preferable molecular weight thereof is about 500 to 5000.

In the case where terephthalic acid is used in the esterification reaction, the reaction may be performed without a catalyst due to the catalytic action of terephthalic acid as an acid.

After adding an organic sulfonic acid-based compound to the esterified product thus obtained, an etherification reaction is performed. An polycondensation reaction is then allowed to proceed, so that a polyester resin of the present invention can be obtained.

### Catalyst

In the present invention, by using an organic sulfonic acid-based compound as polymerization catalyst, the content of triethylene glycol and tetraethylene glycol in the resulting polyester resin can be controlled within the range of the present invention. Examples of the organic sulfonic acid-based compound include benzenesulfonic acid, m- or p-benzenedisulfonic acid, 1,3,5-benzenetrisulfonic acid, o-, m- or p-sulfobenzoic acid, benzaldehyde-o-sulfonic acid, acetophenone-p-sulfonic acid, acetophenone-3,5-disulfonic acid, o-, m- or p-aminobenzenesulfonic acid, sulfanilic acid, 2-aminotoluene-3-sulfonic acid, phenylhydroxylamine-3 -sulfonic acid, phenylhydrazine-3-sulfonic acid, 1-nitronaphthalene-3-sulfonic acid, thiophenol-4-sulfonic acid, anisole-o-sulfonic acid, 1,5-naphthalenedisulfonic acid, o-, m- or p-chlorobenzenesulfonic acid, o-, m- or p-bromobenzenesulfonic acid, o-, m- or p-nitrobenzenesulfonic acid, nitrobenzene-2,4-disulfonic acid, nitrobenzene-3,5-disulfonic acid, nitrobenzene-2,5-disulfonic acid, 2-nitrotoluene-5-sulfonic acid, 2-nitrotoluene-4-sulfonic acid, 2-nitrotoluene-6-sulfonic acid, 3-nitrotoluene-5-sulfonic acid, 4-nitrotoluene-2-sulfonic acid, 3-nitro-o-xylene-4-sulfonic acid, 5-nitro-o-xylene-4-sulfonic acid, 2-nitro-m-xylene-4-sulfonic acid, 5-nitro-m-xylene-4-sulfonic acid, 3-nitro-p-xylene-2-sulfonic acid, 5-nitro-p-xylene-2-sulfonic acid, 6-nitro-p-xylene-2-sulfonic acid, 2,4-dinitrobenzenesulfonic acid, 3,5-dinitrobenzenesulfonic acid, o-, m- or p-fluorobenzenesulfonic acid, 4-chloro-3-methylbenzenesulfonic acid, 2-chloro-4-sulfobenzoic acid, 5-sulfosalicylic acid, 4-sulfophthalic acid, 2-sulfobenzoic acid anhydride, 3,4-dimethyl-2-sulfobenzoic acid anhydride, 4-methyl-2-sulfobenzoic acid anhydride, 5-methoxy-2-sulfobenzoic acid anhydride, 1-sulfonaphthoic acid anhydride, 8-sulfonaphthoic acid anhydride, 3,6-disulfophthalic acid anhydride, 4,6-disulfoisophthalic acid anhydride, 2,5-disulfoterephthalic acid anhydride, methanesulfonic acid, ethanesulfonic acid, methionic acid, cyclopentanesulfonic acid, 1,1-ethanedisulfonic acid, 1,2-ethanedisulfonic acid, 1,2-ethanedisulfonic acid anhydride, 3-propanedisulfonic acid, β-sulfopropionic acid, isethionic acid, dithionic acid, dithionic acid anhydride, 3-oxy-1-propanesulfonic acid, 2-chloroethanesulfonic acid, phenylmethanesulfonic acid, β-phenylethanesulfonic acid, α-phenylethanesulfonic acid, ammonium chlorosulfonate, methyl benzenesulfonate, ethyl p-toluenesulfonate, ethyl methanesulfonate, dimethyl 5-sulfosalicylate, trimethyl 4-sulfophthalate, and salts thereof. In particular, from the viewpoint of versatility, 2-sulfobenzoic acid anhydride, o-sulfobenzoic acid, m-sulfobenzoic acid, p-sulfobenzoic acid, 5-sulfosalicylic acid, benzenesulfonic acid, o-aminobenzenesulfonic acid, m-aminobenzenesulfonic acid, p-aminobenzenesulfonic acid, p-toluenesulfonic acid, methyl p-toluenesulfonate, 5-sulfoisophthalic acid, and salts thereof are preferred.

To the raw material polyester, the organic sulfonic acid-based compound may be added, for example, in a solid form, in a slurry form, or as a solution dissolved in water, glycol or the like.

The amount of the organic sulfonic acid-based compound added depends on the type, being preferably 0.5×10⁻¹ to 40×10⁻⁴ mol, more preferably 1.0×10⁻¹ to 20.0×10⁻¹ mol, relative to 1 mol of the acid component constituting the polyester resin. With an amount added of less than the range, a polyester resin having a high polymerization degree may not be obtained in a short time, or diethylene glycol and triethylene glycol may not be simultaneously contained. Further, the content of triethylene glycol may excessively decreases. On the other hand, with an amount added of more than the range, formation of side reaction products or coloring of the polyester resin may be caused.

By controlling the amount of the organic sulfonic acid-based compound in the range, the content of sulfur component in the resulting polyester resin is controlled to preferably 1 to 500 ppm, more preferably 2 to 250 ppm, still more preferably 2 to 50 ppm. With a content of sulfur component of less than 1 ppm, the mechanical properties may be poor. On the other hand, with a content of more than 500 ppm, formation of side reaction products or coloring of the polyester may be caused.

In the case where a metal-based catalyst is not used as the polymerization catalyst, it is possible to reduce the content of the metal component derived from the metal-based catalyst in the resulting polyester resin of the present invention. With a large content of the metal component, the transparency may be poor or foreign matter may be generated during a melting process. The content of the metal component is preferably 1 ppm or less, more preferably 0.5 ppm or less, and still more preferably 0 ppm. Examples of the metal-based catalyst include compounds of antimony, germanium, tin, titanium, zinc, aluminum, iron, magnesium, potassium, calcium, sodium, manganese, nickel or cobalt.

### Etherification Reaction

The temperature of the etherification reaction is preferably 240° C. or more, more preferably 240 to 300° C., and still more preferably 250° C. to 280° C. With a temperature of less than 240° C., the reaction insufficiently proceeds, so that the glycol component of the polyester resin may not simultaneously contain diethylene glycol and triethylene glycol. In addition, the content of diethylene glycol, the content of tetraethylene glycol, and the total content of triethylene glycol and tetraethylene glycol may be out of the preferable range. With a temperature of the etherification reaction of more than 300° C., decomposition of an esterified product proceeds during the reaction, so that the resulting polyester resin may have reduced mechanical properties such as rapture elongation when formed into a molded body.

The etherification reaction time (heating time) is preferably 5 to 120 minutes, more preferably 10 to 60 minutes. With a reaction time of less than 5 minutes, the etherification reaction insufficiently proceeds, so that the glycol component of the polyester resin may not simultaneously contain diethylene glycol and triethylene glycol, and the content of triethylene glycol may not be controlled within a specific range. Further, the content of diethylene glycol, the content of tetraethylene glycol, and the total content of triethylene glycol and tetraethylene glycol may deviate from the preferable ranges. With a reaction time of more than 120 minutes, the decomposition of the esterified product proceeds during the reaction, and the resulting polyester resin may have reduced mechanical properties.

It is preferable that the etherification reaction be performed under normal pressure or increased pressure, and the pressure is preferably 0 to 3.0 kg/cm²/G.

By adjusting the molar ratio between a glycol component (G) and an acid component (A), i.e. (G/A), in the raw material to be supplied to the etherification reaction, diethylene glycol and triethylene glycol can be simultaneously contained in the polyester resin, and the amounts of diethylene glycol, triethylene glycol, and tetraethylene glycol produced can be adjusted. G/A is preferably 1.05 to 3.00, more preferably 1.10 to 2.00. In order to adjust G/A, a glycol component such as ethylene glycol may be additionally added to the raw material polyester resin on an as needed basis. With G/A of less than 1.05, the amounts of triethylene glycol and tetraethylene glycol produced may excessively decrease, while with G/A of more than 3.00, the amounts of triethylene glycol and tetraethylene glycol produced excessively increase.

### Polymerization Reaction

After the etherification reaction, a polycondensation reaction may be performed to obtain the polyester resin of the present invention. Examples of the polycondensation reaction include a melt polycondensation reaction. The polycondensation reaction may be performed in one stage or may be performed in separate multiple stages.

Although the conditions for polycondensation reaction are not particularly limited, in the first-stage polycondensation reaction, the temperature is preferably 250 to 290° C., more preferably 260 to 280° C. The pressure is preferably 500 to 20 Torr, more preferably 200 to 30 Torr.

In the case of multiple stages, the temperature of the polycondensation reaction in the final stage is preferably 265 to 300° C., preferably 275 to 295° C. The pressure is preferably 10 to 0.1 Torr, more preferably 5 to 0.5 Torr. In the case where the reaction is performed in three or more stages, it is preferable that the reaction conditions in an intermediate stage be reaction conditions between the first stage and the final stage. It is preferable that the degree of polymerization be smoothly increased at each stage.

In order to increase the polymerization degree of the polyester resin, solid phase polymerization may be further performed after the polycondensation reaction. A conventionally known method can be adopted for the solid phase polymerization. For example, first, polyester before subjected to solid phase polymerization is heated at a temperature of 100 to 210° C. for 1 to 5 hours under an inert gas atmosphere or a reduced pressure, or under a steam or steam-containing inert gas atmosphere for preliminary crystallization. Subsequently, solid-phase polymerization is performed at a temperature of 190 to 230° C. for 1 to 30 hours under an inert gas atmosphere or under reduced pressure.

Further, before solid phase polymerization, in order to accelerate crystallization of the polyester resin, the polyester obtained by the polycondensation reaction may be moisturized and then crystallized by heating, or water vapor may be directly blown onto polyester chips to be crystallized by heating.

In particular, it is preferable that polyester resins used for applications requiring a low content of acetaldehyde or cyclic trimer, including heat-resistant hollow molded bodies for low-flavor beverages or bottled water, be solid-phase polymerized after melt polycondensation reaction.

For the polycondensation reaction or the solid phase polymerization reaction, a batch-type reaction apparatus or a continuous reaction apparatus may be used. The polycondensation reaction and the solid-phase polymerization reaction may be performed continuously or separately.

After polymerization, the catalyst is removed or inactivated by addition of a basic compound, so that the thermal stability can be further enhanced.

In the case where the polyester resin of the present invention contains another resin or an additive and the like, the addition stage is not particularly limited and may be selected according to the characteristics of the additive or the performance required for the polyester resin. For example, the addition may be performed at any stage during or after polymerization of the polyester resin, or during forming of the polyester resin.

### Use of Polyester Resin

### Fiber

The polyester resin of the present invention may be formed into a fiber form. In order to form the fiber, a conventional melt spinning method may be adopted, and for example, a method including performing spinning and drawing in two steps, or a method including performing spinning and drawing in one step may be adopted. Further, the fiber may be crimped, heat-set, or cut to make staples (short fibers).

In the case of short fibers, the fibers may contain a filler in order to improve spinning operability and dispersibility for use in papermaking. Examples of the filler include an inorganic substance such as silica and organic filler.

Further, in the case of filaments (long fibers), the fibers may contain an additive such as a non-metallic matting agent in order to impart slipperiness and concealing properties.

The fiber may be a thread having a modified cross section, a thread having a hollow cross section, a composite fiber, or a spun dyed thread. Further, for example, known thread processing means such as fiber mixing or blended spinning may be adopted to obtain a processed yarn.

The polyester fiber may be processed into a woven or knitted fabric, a nonwoven fabric, and the like. For example, the polyester fiber may be used for various fiber applications such as clothing fiber, fiber for interior/bedding typified by curtains, carpets, wadding, and fiber fills, tensile strength wires such as tire cords and ropes, civil engineering/building materials, fibers for industrial materials typified by vehicle materials such as airbags, various woven fabrics, various knitted fabrics, nets, short fiber non-woven fabrics, and long fiber nonwoven fabrics.

The nonwoven fabric may be not only a simple substance but also, for example, a laminate having two or more multilayers made of non-woven fabrics, a non-woven fabric and a film, or the like. The nonwoven fabrics may be used for industrial materials such as a support of membranes or filter media, various filters, battery separators, and house wraps, medical applications such as masks and medical gowns, clothing applications, carpet applications, packaging materials, reinforcing materials for rubber products such as tires, belts, hoses and tarpaulins, heavy cloths, ropes, nets, etc.

### Molded Body

The polyester resin of the present invention may be formed into a molded body such as a hollow molded body. Examples of the hollow molded body include containers of beverages such as bottled water, juice, wine and whiskey, nursing bottles, bottled food containers, containers of hairdressing agents or cosmetics, and containers for detergent for dwellings and dishes. Taking advantage of the hygiene, strength, and solvent resistance of the polyester resin, a form of pressure-resistant container, heat-resistant pressure-resistant container, or alcohol-resistant container is particularly suitable for various beverages.

As a method for producing a hollow molded body, a method including drying polyester chips by a vacuum drying method or the like and then forming using a forming machine such as an extruder or an injection molding machine, or a blow molding method including introducing a melt after melt polymerization directly into a forming machine to obtain a bottomed preformed molded body by direct forming, and subjecting the bottomed preformed molded body to stretch blow molding, direct blow molding, or extruded blow molding may be employed.

The hollow container may have a multi-layer structure such as a laminated bottle. Examples thereof include a multi-layer structure having a gas barrier resin layer made of polyvinyl alcohol or polymetaxylylene diamine adipate, a light-shielding resin layer, or a recycled polyester layer as an intermediate layer. Alternatively, the inside and outside of a container may be coated with a layer of metal such as aluminum or diamond-like carbon by a method such as vapor deposition or CVD (chemical vapor deposit).

The polyester resin of the present invention may also be used for hot melt molding or potting applications.

The hot melt molding method refers to a method including injection molding a resin melted without solvent into a mold, in which industrial parts (in particular, electronic parts) are arranged in advance, at a low pressure (preferably from 0.1 to 3 MPa) for forming of a resin as a housing or case of the parts (so-called insert molding).

The potting method refers to a method including placing industrial parts in a housing or on a substrate in advance, and injecting or dropping a molten resin onto the parts at a low pressure (preferably 1 MPa or less) for integration of the housing or the substrate with the parts.

Further, the polyester resin of the present invention may be mixed with a heat conductive filler and formed into a desired shape by a commonly known melt molding method such as injection molding, compression molding, extrusion, transfer molding and sheet forming, so as to obtain a heat conductive molded body.

Specific examples of the heat conductive molded body include encapsulants such as semiconductor devices and resistors, electrical and electronic parts such as connectors, sockets, and computer-related parts, household electrical product parts, heat dissipation sheets and heat dissipation parts for releasing heat from electronic parts to the outside, lighting equipment parts such as lamp sockets, communication equipment parts, printing machine-related parts, mechanical parts such as gears, bearings, motor parts and cases, automobile parts such as automobile mechanical elements, engine parts, engine compartment parts, electrical parts and interior parts, cooking utensils such as heat-resistant tableware, parts for aircraft, spacecraft and space equipment, and sensor parts.

### Sheet

The polyester resin of the present invention can be formed into a sheet. The sheet may be produced, for example, by extruding a polyester resin from an extruder into a sheet-like material. The sheet may be further processed by vacuum forming, air pressure forming, embossing or the like. Examples of the use of the sheet include trays or containers for foods or miscellaneous goods, cups, blister packs, carrier tapes for electronic parts, trays for delivering electronic parts, and various cards. The sheet may also include a multi-layer structure having a gas barrier resin layer, a light-shielding resin layer, a recycled polyester layer or the like as an intermediate layer.

### Film

The polyester resin of the present invention may be formed into a film. Examples of the method for forming into a film include a method including melt-extruding a polyester resin and forming the resin into a sheet on a cooling rotary roll from a T-die to make an unstretched film. Alternatively, with use of a plurality of extruders to form a laminated film by a coextrusion method, various functions may be assigned to the core layer and the skin layer, respectively.

The film may be oriented. The oriented film may be produced, for example, by a known method including stretching at least in the uniaxial direction under the ratio of 1.1 to 6 times at a temperature equal to or more than the glass transition temperature of the polyester resin and less than the crystallization temperature.

Examples of the method for producing a film oriented in biaxial directions include a sequential biaxial stretching method including uniaxial stretching in the longitudinal direction or the lateral direction and then stretching in the orthogonal direction, and a simultaneous biaxial stretching method including stretching in the longitudinal direction and the lateral direction simultaneously. In addition, examples of the driving method for simultaneous biaxial stretching include a method using a linear motor and a multi-stage stretching method including stretching in the same direction in plural times such as a lateral/longitudinal/longitudinal stretching method, a longitudinal/lateral/longitudinal stretching method, and a longitudinal/longitudinal/lateral stretching method. After completion of stretching, in order to reduce the heat shrinkage rate of a film, it is preferable that for example, a heat fixing treatment be performed at a temperature of “melting point minus 50° C.” to less than melting point within 30 seconds (preferably within 10 seconds) for a longitudinal relaxation treatment or a lateral relaxation treatment of 0.5 to 10%.

The thickness of the film is preferably 1 to 1000 μm, more preferably 5 to 500 μm, and still more preferably 10 to 200 μm. With a thickness of less than 1 μm, the film is too soft, while with a thickness of more than 1000 μm, the film is too hard, which may result in difficulty in handling in both cases.

In order to impart various functions such as adhesiveness, releasability, antistatic property, infrared absorption, antibacterial property, and scratch resistance to the surface of a film, a coating layer made of polymer resin may be provided, for example, by a coating method. Alternatively, by containing inorganic particles and/or organic particles only in the coating layer, an easy-to-slip highly transparent film may be obtained. Further, it is also possible to impart various barrier functions against oxygen, water, or oligomers by providing an inorganic deposition layer on the surface of a film, and to impart conductivity by providing a conductive layer by a sputtering method or the like.

Further, in order to improve handling properties such as slipperiness, travelling properties, abrasion resistance and winding properties, inert particles such as inorganic particles, organic salt particles, and crosslinked polymer resin particles may be contained to make irregularities in the film surface. The inert particles may be added at any stage during or after polymerization of the polyester resin or after formation of the film.

The inert particles may be inorganic, organic, surface-treated to make hydrophilic or hydrophobic, or untreated. Use of surface-treated particles may be preferred, for example, in order to improve dispersibility in some cases.

Examples of the inorganic particles include calcium carbonate, kaolin, talc, magnesium carbonate, barium carbonate, calcium sulfate, barium sulfate, lithium phosphate, calcium phosphate, magnesium phosphate, aluminum oxide, silicon oxide, titanium oxide, zirconium oxide, lithium fluoride, and sodium calcium aluminum silicate.

Examples of the organic salt particles include such as calcium oxalate and terephthalate of calcium, barium, zinc, manganese, or magnesium.

Examples of the crosslinked polymer resin particles include a homopolymer or copolymer of a vinyl-based monomer such as divinylbenzene, styrene, acrylic acid, and methacrylic acid. Other examples thereof include organic particles of polytetrafluoroethylene, benzoguanamine resin, thermosetting epoxy resin, unsaturated polyester resin, thermosetting urea resin, and thermosetting phenol resin.

Examples of the method for containing the inert particles include the following methods (a) to (d), though not limited thereto.
(a) A method including dispersing inert particles in a slurry state in the glycol component as a constituent of the polyester resin and adding the dispersion to the polymerization reaction system of polyester.
(b) A method including adding water slurry of dispersed inert particles to a molten polyester resin using a vent type twin-screw extruder in a melt extrusion step.
(c) A method including kneading a polyester resin and inert particles in a molten state.
(d) A method including kneading a polyester resin and a master resin of inert particles in a molten state.

In the case of the method (a), it is preferable that the inert particle slurry be added to the reaction system having a low melt viscosity before the start of the polycondensation reaction before the esterification reaction or the transesterification reaction. Further, on the occasion of preparing an inert particle slurry, it is preferable that a physical dispersion treatment be performed using a high-pressure disperser, a bead mill, or an ultrasonic disperser. Further, in order to stabilize the dispersion-treated slurry, it is preferable that an appropriate chemical dispersion stabilization treatment be used in combination depending on the type of particles used.

In the case of crosslinked polymer resin particles having a carboxyl group on the particle surface, examples of the dispersion stabilization treatment include adding an alkaline compound such as sodium hydroxide, potassium hydroxide, and lithium hydroxide to a slurry to suppress reaggregation of particles by electrical repulsion. In the case of calcium carbonate particles, hydroxyapatite particles, etc., it is preferable that sodium tripolyphosphate and potassium tripolyphosphate be added to the slurry.

Further, on the occasion of adding an inert particle slurry to a polymerization reaction system of polyester, it is preferable that the slurry be heat-treated up to near the boiling point of the glycol component, in order to reduce the heat shock (temperature difference between the slurry and the polymerization reaction system) during addition to the polymerization reaction system for improvement in the dispersibility.

Since the polyester resin of the present invention has excellent thermal stability, for example, on the occasion of producing a film or the like, end portions of the film generated in the stretching step or a nonstandard film may be melted for reuse.

The film of the present invention is used, for example, for an antistatic film, an easily adhesive film, a card, a dummy can, agriculture, a building material, a decorative material, a wallpaper, an OHP film, printing, an inkjet recording, sublimation transfer recording, laser beam printer recording, electrophotographic recording, thermal transfer recording, heat-sensitive transfer recording, printed circuit board wiring, a membrane switch, a plasma display, a touch panel, a masking film, photoengraving, a Roentgen film, a photographic negative film, a retardation film, a polarizing film, polarizing film protection (TAC), a protective film, a photosensitive resin film, a view expansion film, a diffusion sheet, a reflective film, an anti-reflection film, a conductive film, a separator, UV protection, and a back grind tape.

### Adhesive

The polyester resin of the present invention is preferably used as an adhesive. The adhesive may contain a solvent or various additives.

In the case of using the polyester resin of the present invention as a hot melt adhesive, various methods may be employed, including a method including forming the resin into various shapes such as a pellet, powder, sheet, film, and non-woven fabric, so as to be sandwiched between adherends and heat bonded, a method including applying the resin to an adherend using a melt applicator and then performing lamination, and a method including applying a coating in a film or tube shape to an adherend using an extruder and then performing lamination.

Further, the polyester resin of the present invention may also be made into a heat conductive composition by mixing with a heat conductive filler. Specific examples of the heat conductive composition include those listed for the molded bodies.

### Powder

The polyester resin of the present invention may be processed into powder for use as raw material to be filled in a mold in production of a resin molded body through compression forming, or for use as filler to be compounded in a resin. A resin molded body obtained from polyester resin powder as raw material may be used, for example, for a connector and an LED reflector. Further, a resin containing a polyester resin filler may be used, for example, as an abrasive.

The powder may also be used as a powder paint. The powder paint may be used, for example, for a bicycle basket, gardening equipment, kitchen utensils, clothing fittings, a refrigerator shelve, a freezer showcase, a dishwasher basket, a handle, a shopping cart, a fence, a grating, a steel pipe spliced pole down pipe, a branch anchor part, a building spacer, a protective shelve, a steel pipe, a panel tank, a valve, an automobile part, a vehicle handle, a rail fastener, a bonnet stay, an outdoor unit fan cover, a booth bar, a telephone pole, a telephone cable part, a pole line hardware band, an electric wire pipe joint, an industrial piping, piping equipment, flanges and valves, a sulfuric acid tank, a tank truck inner surface, joint inner surface painting, piping equipment, a heat exchanger, urine treatment equipment, and a plating jig.

### Resin Solution

The polyester resin of the present invention may be dissolved or dispersed in various solvents, being applicable to various uses in the form of resin solution. In the present invention, the resin solution includes both a solution in which the polyester resin is dissolved and a solution in which the polyester resin is dispersed.

Examples of the solvents include water, methanol, ethanol, propanol, isopropanol, acetone, methyl ethyl ketone, methyl acetate, ethyl acetate, hexafluoroisopropanol, methylene chloride, chloroform, tetrachloroethane, trifluoroacetic acid, benzene, toluene, xylene, cresol, trimethylbenzene, triethylamine, triethanolamine, dimethylacetamide (DMAc), dimethylformamide (DMF), dimethylsulfoxide, N-methyl-2-pyrrolidone (NMP), γ-butyrolactone, sulfolane, and cyclohexanone. The solvent may be used alone or in combination of two or more. Further, the solvent may be mixed with a solvent other than the solvents described above. The solvent may be appropriately selected in consideration of the type of polyester resin, the degree of polymerization, the desired concentration and the like.

The resin solution may contain an additive such as an inorganic filler, a binder, an antioxidant, a wetting agent, and a leveling agent.

In the case of using the polyester resin of the present invention by reacting with another resin or a curing agent, the resin solution of the present invention and the solution of the other resin or the curing agent may be prepared, respectively, mixed immediately before use, and then applied and dried such that both the resins may be reacted and cured.

A coating film, a laminate, a film, etc. may be formed by applying and drying the resin solution of the present invention. Specific examples of the substrate that can be used for forming the coating film and the laminate include a glass substrate, various metal plates, a polyethylene terephthalate film, a polycarbonate film, a cycloolefin film, a polyimide film, and a polyamide film.

The method for applying the resin solution to the substrate is not particularly limited, and examples thereof include wire bar coater coating, film applicator coating, spray coating, a gravure roll coating method, a screen printing method, a reverse roll coating method, lip coating, an air knife coating method, a curtain flow coating method, a dip coating method, a die coating method, a spray method, a relief printing method, an intaglio printing method, and an inkjet method. The coating film may be formed by using a conventional method and apparatus, being obtained by applying the resin solution of the present invention to a substrate and drying the solvent component.

The resin solution of the present invention may be used as a can paint. Examples of the metal plate as equipment to which a can paint is applied include a sheet-shaped or strip-shaped steel plate, an aluminum plate, and the plates with a surface subjected to various plating treatments or chemical conversion treatments. The resin solution applied on a metal plate is baked to form a coating film on the metal surface. The metal plate having a coating film may be used as a member requiring processability such as a can body and a top lid of a two-piece can, and a can body and a bottom lid of a three-piece can.

The resin solution of the present invention may also be used for a separator for a power storage device such as a lithium ion secondary battery. A porous film prepared from the resin solution may be used as a separator, or a porous film on both sides or one side of an existing separator formed from the resin solution of the present invention may be used as a separator.

The resin solution of the present invention may also be used for producing a prepreg. The prepreg may be obtained by drying a reinforced fiber cloth impregnated or coated with the resin solution of a compound to be polymerized with polyester dissolved in an organic solvent.

The resin solution of the present invention may also be used for a paint, a coating agent, an adhesive, a varnish, etc.

The various articles (a coating film, a film, various part materials, a coating film, etc.) produced from the resin solution of the present invention may be further subjected to an annealing treatment. Thereby, the resin is further cured, so that the heat resistance, hardness, etc., may be improved. The annealing temperature is, for example, equal to or more than the drying temperature, preferably about 100° C. to 280° C.

### EXAMPLES

Hereinafter, the present invention will be specifically described based on Examples, though the present invention is not limited thereto. The measurement and evaluation were performed by the following methods.

### (1) Limiting Viscosity [η]

The measurement was performed at a temperature of 20° C. in an equal weight mixture of phenol and ethane tetrachloride as solvent.

### (2) Composition of Polyester Resin

In 1 mL of a mixed solvent of deuterated chloroform/deuterated trifluoroacetic acid=^{9/1} (mass ratio), 10 mg of a sample was dissolved, and ¹H-NMR was measured with LA-400 type NMR manufactured by JEOL Ltd. From the peak integrated intensity of protons of each component in the resulting chart, the molar ratio among the dicarboxylic acid component, the total components of triethylene glycol and tetraethylene glycol, and the other glycol components was calculated.

Further, the polyester resin was hydrolyzed in a 0.75 N potassium hydroxide/methanol solution and then neutralized by adding terephthalic acid. Subsequently, the filtrate obtained by filtration was measured by gas chromatography, and quantified based on a calibration line prepared in advance so as to calculate the molar ratio between triethylene glycol and tetraethylene glycol. Based on the molar ratio thereof and ¹H-NMR measurement results (molar ratio between the total components of triethylene glycol and tetraethylene glycol and other glycol components), the molar ratio of triethylene glycol and the molar ratio of tetraethylene glycol in the total glycol components were calculated.

### (3) Melting Point (Tm) and Glass Transition Temperature

Using a differential scanning calorimeter DSC-7 manufactured by PerkinElmer, measurements were performed in a nitrogen stream at a temperature range of 25 to 280° C., at a heating rate of 20° C./min.

### (4) Content of Sulfur Component and Content of Metal Component

Through melt forming of polyester resin at 300° C., a disk-shaped plate molding with a diameter of 3 cm and a thickness of 1 cm was obtained and subjected to quantitative analysis by the calibration curve method using an X-ray fluorescent analyzer ZSX Primus manufactured by Rigaku Corporation.

### (5) Tensile Properties of Molded Body

A test piece (ISO type) for measuring general physical properties was obtained from the polyester resin. According to ISO527, the tensile elastic modulus, tensile yield strength, and tensile elongation were measured at a tensile speed of 5 mm/min, and the tensile elastic modulus was measured at a tensile speed of 1 mm/min, for the respective calculations.

### (6) Haze

The polyester resin was fed into a NEX110 type injection molding machine manufactured by Nissei Plastic Industrial Co., Ltd. at a cylinder temperature of 285° C. and a mold temperature of 40° C. to prepare a plate having a length of 90 mm, a width of 50 mm and a thickness of 2 mm. The turbidity of the resulting plate was evaluated by a turbidity meter MODEL 1001DP manufactured by Nippon Denshoku Industries Co., Ltd. The smaller the value, the better the transparency. For example, the haze of air is 0%.

### Preparation of Esterified Product A

To an esterification reactor, a slurry of terephthalic acid and ethylene glycol (terephthalic acid:ethylene glycol=1:1.6 (molar ratio)) was continuously supplied to cause a reaction at a temperature of 250° C. and a pressure of 0.2 MPa. After a residence time of 8 hours, an esterified product A (terephthalic acid:ethylene glycol=100:111 (molar ratio)) was obtained.

### Preparation of Esterified Product B

To an esterification reactor, a slurry of isophthalic acid and ethylene glycol (isophthalic acid:ethylene glycol=1:3.5 (molar ratio)) was supplied to cause a reaction at a temperature of 200° C. and a pressure of 0.2 MPa for 4 hours. Thereby, an esterized product B (isophthalic acid:ethylene glycol=100:332 (molar ratio)) was obtained.

### Example 1

A heat-melted esterified product A was fed into a polycondensation reactor heated to 280° C., and 2-sulfobenzoic anhydride (OSB) in an amount of 2.0×10⁻⁴ mol/mol acid component was added to perform an etherification reaction under normal pressure at 280° C. for 10 minutes.

Subsequently, while maintaining the temperature of the reactor at 280° C., the pressure of the system was gradually reduced to 0.5 hPa or less after 60 minutes. The polycondensation reaction was performed for 3 hours while stirring under the conditions to obtain a polyester resin. The polyester resin contained 12 ppm of sulfur component, with triethylene glycol in an amount of 0.8 mol %.

### Examples 2 to 6

A polyester resin was obtained by the same operation as in Example 1, except that the organic sulfonic acid-based compound was replaced with 5-sulfosalicylic acid dihydrate (SS), o, m, p-aminobenzenesulfonic acid (o, m, p-ABS), or methyl p-toluenesulfonate (p-TSMe), in each Example. All the polyester resins contained 1 to 32 ppm of sulfur component, with triethylene glycol in an amount of 0.2 to 0.9 mol %.

### Example 7

A heat-melted esterified product A was fed into a polycondensation reactor heated to 250° C., and 5-sulfosalicylic acid dihydrate (SS) was added in an amount of 2.0×10⁻¹ mol/mol acid component to perform an etherification reaction under normal pressure at 250° C. for 60 minutes.

Subsequently, the temperature of the reactor was raised to 280° C. in 10 minutes, and the pressure of the system was gradually reduced to 0.5 hPa or less after 60 minutes while maintaining the temperature. The polycondensation reaction was performed for 4 hours while stirring under the conditions to obtain a polyester resin. The polyester resin contained 12 ppm of sulfur component, with triethylene glycol in an amount of 1.1 mol %.

### Example 8

A polyester resin was obtained by the same operation as in Example 7, except that the etherification reaction time was changed to 120 minutes. The polyester resin contained 12 ppm of sulfur component, with triethylene glycol in an amount of 1.2 mol %.

### Example 9

A heat-melted esterified product A was fed into a polycondensation reactor heated to 250° C., and 5-sulfosalicylic acid dihydrate (SS) was added in an amount of 2.0×10⁻⁴ mol/mol acid component to perform an etherification reaction under normal pressure at 250° C. for 180 minutes. Subsequently, the temperature of the reactor was raised to 280° C. in 10 minutes, and the pressure of the system was gradually reduced to 0.5 hPa or less after 60 minutes while maintaining the temperature. The polycondensation reaction was performed for 5 hours while stirring under the conditions to obtain a polyester resin. The polyester resin contained 21 ppm of sulfur component, with triethylene glycol in an amount of 1.8 mol %.

### Example 10

A heat-melted esterified product A (100 parts by mass) was fed into a polycondensation reactor heated to 250° C., and ethylene glycol (EG) (6 parts by mass) was further fed into the polycondensation reactor to adjust G/A to 1.31. Then, 5-sulfosalicylic acid dihydrate (SS) was added in an amount of 2.0×10⁻⁴ mol/mol acid component to perform an etherification reaction under normal pressure at 250° C. for 30 minutes.

Subsequently, the temperature of the reactor was raised to 280° C. in 10 minutes, and the pressure of the system was gradually reduced to 0.5 hPa or less after 60 minutes while maintaining the temperature. The polycondensation reaction was performed for 4 hours while stirring under the conditions to obtain a polyester resin. The polyester resin contained 12 ppm of sulfur component, with triethylene glycol in an amount of 2.8 mol % and tetraethylene glycol in an amount of 0.1 mol %.

### Example 11

A polyester resin was obtained by the same operation as in Example 10 except that the etherification reaction time was changed to 60 minutes. The polyester resin contained 15 ppm of sulfur component, with triethylene glycol in an amount of 3.4 mol % and tetraethylene glycol in an amount of 0.2 mol %.

### Example 12

A polyester resin was obtained by the same operation as in Example 11, except that 12 parts by mass of ethylene glycol was fed to adjust G/A to 1.51. The polyester resin contained 14 ppm of sulfur component, with triethylene glycol in an amount of 2.8 mol % and tetraethylene glycol in an amount of 0.2 mol %.

### Example 13

A heat-melted esterified product A (100 parts by mass) was fed into a polycondensation reactor heated to 250° C., and ethylene glycol (62 parts by mass) was further fed therein to adjust G/A to 3.11. Then, 5-sulfosalicylic acid dihydrate (SS) was added thereto in an amount of 2.0×10⁻⁴ mol/mol acid component to perform an etherification reaction at 250° C. for 60 minutes under normal pressure.

Subsequently, the temperature of the reactor was raised to 280° C. in 10 minutes, and the pressure of the system was gradually reduced to 0.5 hPa or less after 60 minutes while maintaining the temperature. The polycondensation reaction was performed for 5 hours while stirring under the conditions to obtain a polyester resin. The polyester resin contained 25 ppm of sulfur component, with triethylene glycol in an amount of 5.3 mol % and tetraethylene glycol in an amount of 0.4 mol %.

### Example 14

A heat-melted esterified product A (100 parts by mass) and an esterified product B (19 parts by mass) were fed into a polycondensation reactor heated to 260° C., and 5-sulfosalicylic acid dihydrate (SS) was added thereto in an amount of 2.0×10⁻⁴ mol/mol acid component to perform an etherification reaction at 260° C. for 10 minutes under normal pressure.

Subsequently, the temperature of the reactor was raised to 280 ° C. in 10 minutes, and the pressure of the system was gradually reduced to 0.5 hPa or less after 60 minutes while maintaining the temperature. The polycondensation reaction was performed for 4 hours while stirring under the conditions to obtain a polyester resin. The polyester resin contained 10 ppm of sulfur component, with triethylene glycol in an amount of 1.6 mol % and tetraethylene glycol in an amount of 0.1 mol %.

### Examples 15 to 20

A polyester resin was obtained by performing the same operation as in Example 14, except that the amount of an esterified product B fed was changed as shown in Table 2 in each Example. All the polyester resins contained 10 to 15 ppm of sulfur component, with triethylene glycol in an amount of 1.9 to 3.6 mol % and tetraethylene glycol in an amount of 0.1 to 0.3 mol %.

### Example 21

Into a polycondensation reactor heated to 260° C., 100 parts by mass of a heat-melted esterified product A, 5.3 parts by mass of terephthalic acid (TPA), and 4.6 parts by mass of 1,4-cyclohexanedimethanol (CHDM) were fed, and heating and mixing were performed for 1 hour in a nitrogen atmosphere at 0.05 MPa.

Subsequently, after raising the temperature of the reactor to 280° C., 5-sulfosalicylic acid dihydrate (SS) in an amount of 2.0×10⁻⁴ mol/mol acid component was added thereto to perform an etherification reaction under normal pressure for 10 minutes.

Then, while maintaining the temperature, the pressure of the system was gradually reduced to 0.5 hPa or less after 60 minutes. The polycondensation reaction was performed for 3 hours while stirring under the conditions to obtain a copolymerized polyester resin.

The copolymerized polyester resin contained 16 ppm of sulfur component, with triethylene glycol in an amount of 0.7 mol %.

### Example 22

A copolymerized polyester resin was obtained by performing the same operation as in Example 21, except that the amount of terephthalic acid was changed to 9.3 parts by mass and the amount of 1,4-cyclohexanedimethanol was changed to 8.1 parts by mass. The copolymerized polyester resin contained 18 ppm of sulfur component, with triethylene glycol in an amount of 0.7 mol %.

### Example 23

Into a polycondensation reactor heated to 260° C., 100 parts by mass of a heat-melted esterified product A, 5.8 parts by mass of terephthalic acid, and 11.1 parts by mass of an ethylene oxide adduct of bisphenol A (BAEO) were fed, and heating and mixing were performed for 1 hour in a nitrogen atmosphere at 0.05 MPa.

Subsequently, after raising the temperature of the reactor to 280° C., 5-sulfosalicylic acid dihydrate (SS) in an amount of 2.0×10⁻⁴ mol/mol acid component was added thereto to perform an etherification reaction under normal pressure for 10 minutes.

Then, while maintaining the temperature, the pressure of the system was gradually reduced to 0.5 hPa or less after 60 minutes. The polycondensation reaction was performed for 3 hours while stirring under the conditions to obtain a copolymerized polyester resin. The copolymerized polyester resin contained 14 ppm of sulfur component, with triethylene glycol in an amount of 0.6 mol

### Example 24

A copolymerized polyester resin was obtained by the same operation as in Example 23, except that the amount of terephthalic acid was changed to 14.8 parts by mass and the amount of ethylene oxide adduct of bisphenol A was changed to 28.1 parts by mass. The copolymerized polyester resin contained 15 ppm of sulfur component, with triethylene glycol in an amount of 0.6 mol %.

### Example 25

A copolymerized polyester resin was obtained by the same operation as in Example 23, except that terephthalic acid was replaced with 3.5 parts by mass of isophthalic acid (IPA), the amount of ethylene glycol (EG) was changed to 0.7 parts by mass and the amount of ethylene oxide adduct of bisphenol A was changed to 3.3 parts by mass. The copolymerized polyester resin contained 8 ppm of sulfur component, with triethylene glycol in amount of 0.8 mol %.

### Example 26

A copolymerized polyester resin was obtained by the same operation as in Example 23, except that the amount of terephthalic acid was changed to 2.2 parts by mass, the amount of isophthalic acid to 3.6 parts by mass, and the amount of ethylene oxide adduct of bisphenol A to 11.1 parts by mass. The copolymerized polyester resin contained 12 ppm of sulfur component, with triethylene glycol in an amount of 0.6 mol %.

### Example 27

Into a polycondensation reactor heated to 260° C., 100 parts by mass of a heat-melted esterified product A, 4.4 parts by mass of terephthalic acid, and 2.8 parts by mass of neopentyl glycol (NPG) were fed, and heating and mixing were performed for 1 hour under a nitrogen atmosphere at 0.05 MPa.

Subsequently, after raising the temperature of the reactor to 280° C., 5-sulfosalicylic acid dihydrate (SS) in an amount of 2.0×10⁻⁴ mol/mol acid component was added thereto to perform an etherification reaction for 10 minutes under normal pressure.

Then, while maintaining the temperature, the pressure of the system was gradually reduced to 0.5 hPa or less after 60 minutes. The polycondensation reaction was performed for 3 hours while stirring under the conditions to obtain a copolymerized polyester resin. The copolymerized polyester resin contained 11 ppm of sulfur component, with triethylene glycol in an amount of 0.6 mol %.

### Example 28

A copolymerized polyester resin was obtained by the same operation as in Example 27, except that the amount of terephthalic acid was changed to 14.8 parts by mass and the amount of neopentyl glycol was changed to 9.2 parts by mass. The copolymerized polyester resin contained 16 ppm of sulfur component, with triethylene glycol in an amount of 0.5 mol %.

### Example 29

Into a polycondensation reactor heated to 260° C., 100 parts by mass of a heat-melted esterified product A, 4.4 parts by mass of terephthalic acid, and 2.4 parts by mass of 3-methyl-1,5-pentanediol (MPD) were fed, and heating and mixing were performed for 1 hour in a nitrogen atmosphere at 0.05 MPa.

Subsequently, after raising the temperature of the reactor to 280° C., 5-sulfosalicylic acid dihydrate (SS) in an amount of 2.0×10⁻⁴ mol/mol acid component was added thereto to perform an etherification reaction under normal pressure for 10 minutes.

Then, while maintaining the temperature, the pressure of the system was gradually reduced to 0.5 hPa or less after 60 minutes. The polycondensation reaction was performed for 3 hours while stirring under the conditions to obtain a copolymerized polyester resin. The copolymerized polyester resin contained 19 ppm of sulfur component, with triethylene glycol in an amount of 0.6 mol %.

### Example 30

A copolymerized polyester resin was obtained by the same operation as in Example 29, except that the amount of terephthalic acid was changed to 9.3 parts by mass and the amount of 3-methyl-1,5-pentanediol was changed to 5.0 parts by mass. The copolymerized polyester resin contained 9 ppm of sulfur component, with triethylene glycol in an amount of 0.5 mol %.

### Example 31

Into a polycondensation reactor heated to 260° C., 100 parts by mass of a heat-melted esterified product A, 4.4 parts by mass of terephthalic acid, and 2.4 parts by mass of 1,4-butylene glycol (BD) were fed, and heating and mixing were performed for 1 hour in a nitrogen atmosphere at 0.05 MPa.

Subsequently, 5-sulfosalicylic acid dihydrate (SS) in an amount of 2.0×10⁻⁴ mol/mol acid component was added thereto to perform an etherification reaction under normal pressure for 10 minutes.

Then, while maintaining the temperature, the pressure of the system was gradually reduced to 0.5 hPa or less after 60 minutes. The polycondensation reaction was performed for 3 hours while stirring under the conditions to obtain a copolymerized polyester resin. The copolymerized polyester resin contained 17 ppm of sulfur component, with triethylene glycol in an amount of 0.6 mol

### Example 32

A copolymerized polyester resin was obtained by the same operation as in Example 31, except that the amount of terephthalic acid was changed to 27.9 parts by mass, the amount of 1,4-butylene glycol was changed to 15.1 parts by mass, and the heating and mixing time was changed to 2 hours. The copolymerized polyester resin contained 18 ppm of sulfur component, with triethylene glycol in an amount of 0.5 mol %.

### Example 33

A copolymerized polyester resin was obtained by the same operation as in Example 31, except that the amount of terephthalic acid was changed to 83.6 parts by mass, the amount of 1,4-butylene glycol was changed to 45.4 parts by mass, and the heating and mixing time was changed to 4 hours. The copolymerized polyester resin contained 14 ppm of sulfur component, with triethylene glycol in an amount of 0.3 mol %.

### Example 34

Into a polycondensation reactor heated to 260° C., 100 parts by mass of a heat-melted esterified product A, 133.8 parts by mass of terephthalic acid, 9.1 parts by mass of ε-caprolactone (ε-CL), and 72.6 parts by mass of 1,4-butylene glycol were fed, and heating and mixing were performed for 5 hours in a nitrogen atmosphere at 0.05 MPa.

Subsequently, 5-sulfosalicylic acid dihydrate (SS) in an amount of 2.0×10⁻⁴ mol/mol acid component was added thereto to perform an etherification reaction under normal pressure for 10 minutes.

Then, while maintaining the temperature, the pressure of the system was gradually reduced to 0.5 hPa or less after 60 minutes. The polycondensation reaction was performed for 3 hours while stirring under the conditions to obtain a copolymerized polyester resin. The copolymerized polyester resin contained 23 ppm of sulfur component, with triethylene glycol in an amount of 0.2 mol %.

### Example 35

same operation as in Example 34, except that the amount of terephthalic acid was changed to 98.4 parts by mass, the amount of ε-caprolactone was changed to 24.1 parts by mass, and the amount of 1,4-butylene glycol was changed to 53.4 parts by mass. The copolymerized polyester resin contained 14 ppm of sulfur component, with triethylene glycol in an amount of 0.3 mol %.

### Example 36

A copolymerized polyester resin was obtained by the same operation as in Example 34, except that the amount of terephthalic acid was changed to 167.2 parts by mass, the amount of ε-caprolactone was changed to 31.5 parts by mass, and the amount of 1,4-butylene glycol was changed to 90.7 parts by mass. The copolymerized polyester resin contained 27 ppm of sulfur component, with triethylene glycol in an amount of 0.2 mol %.

### Comparative Example 1

Into a polycondensation reactor heated to 280° C., a heat-melted esterified product A was fed, and 2-sulfobenzoic anhydride (OSB) in an amount of 2.0×10⁻⁴ mol/mol acid component was added thereto. Without etherification reaction, while maintaining the temperature of the reactor at 280° C., the pressure of the system was gradually reduced to 0.5 hPa or less after 60 minutes. A polycondensation reaction was performed for 3 hours while stirring under the conditions to obtain a polyester resin. The polyester resin contained 10 ppm of sulfur component, with no detection of triethylene glycol and tetraethylene glycol.

### Comparative Example 2

A polyester resin was obtained by the same operation as in Comparative Example 1, except that the organic sulfonic acid-based compound was replaced with 5-sulfosalicylic acid dihydrate (SS). The polyester resin contained 15 ppm of sulfur component, with no detection of triethylene glycol and tetraethylene glycol.

### Comparative Example 3

Into a polycondensation reactor heated to 280° C., a heat-melted esterified product A (100 parts by mass) was fed, and ethylene glycol (12 parts by mass) was further fed to adjust G/A to 1.51. Then, 5-sulfosalicylic acid dihydrate (SS) in an amount of 2.0×10⁻⁴ mol/mol acid component was added thereto. Without etherification reaction, while maintaining the temperature of the reactor, the pressure of the system was gradually reduced to 0.5 hPa or less after 60 minutes. The polycondensation reaction was performed for 4 hours while stirring under the conditions to obtain a polyester resin. The polyester resin contained 13 ppm of sulfur component, with triethylene glycol in an amount of 0.1 mol %.

### Comparative Example 4

Into a polycondensation reactor heated to 230° C., a heat-melted esterified product A was fed, and 5-sulfosalicylic acid dihydrate (SS) in an amount of 2.0×10⁻⁴ mol/mol acid component was added thereto to perform an etherification reaction at 230° C. for 10 minutes under normal pressure.

Subsequently, the temperature of the reactor was raised to 280° C. in 10 minutes, and the pressure of the system was gradually reduced to 0.5 hPa or less after 60 minutes while maintaining the temperature. A polycondensation reaction was performed for 2 hours while stirring under the conditions to obtain a polyester resin. The polyester resin contained 17 ppm of sulfur component, with no detection of triethylene glycol and tetraethylene glycol.

### Comparative Example 5

Into a polycondensation reactor heated to 280° C., a heat-melted esterified product A was fed, and the pressure of the system was gradually reduced to 0.5 hPa or less after 60 minutes to perform a polycondensation reaction for 1 hour. Then, the pressure was returned to normal pressure. The resulting esterified product had G/A of 1.03.

To the esterified product, 5-sulfosalicylic acid dihydrate (SS) in an amount of 2.0×10⁻⁴ mol/mol acid component was added to perform an etherification reaction at 280° C. for 10 minutes under normal pressure.

While maintaining the temperature, the pressure of the system was gradually reduced again to 0.5 hPa or less after 60 minutes. A polycondensation reaction was performed for 1 hour while stirring under the conditions to obtain a polyester resin. The polyester resin contained 30 ppm of sulfur component, with no detection of triethylene glycol and tetraethylene glycol.

### Comparative Example 6

Into a polycondensation reactor heated to 280° C., a heat-melted esterified product A (100 parts by mass) and an esterified product B (42 parts by mass) were fed, and 5-sulfosalicylic acid dihydrate (SS) in an amount of 2.0×10⁻⁴ mol/mol acid component was added thereto. Without etherification reaction, while maintaining the temperature of the reactor, the pressure of the system was gradually reduced to 0.5 hPa or less after 60 minutes. A polycondensation reaction was performed for 4 hours while stirring under the conditions to obtain a polyester resin. The polyester resin contained 20 ppm of sulfur component, with triethylene glycol in an amount of 0.1 %.

### Comparative Example 7

A polyester resin was obtained by the same operation as in Comparative Example 6, except that the amount of the esterified product B fed was changed to 113 parts by mass. The polyester resin contained 19 ppm of sulfur component, with triethylene glycol in an amount of 0.1 mol %.

### Comparative Example 8

Into a polycondensation reactor heated to 280° C., a heat-melted esterified product A was fed, and antimony (Sb) trioxide in an amount of 2.3×10⁻⁴ mol/mol acid component was added thereto. Without etherification reaction, while maintaining the temperature of the reactor at 280° C., the pressure of the system was gradually reduced to 0.5 hPa or less after 60 minutes. A polycondensation reaction was performed for 2 hours while stirring under the conditions to obtain a polyester resin. None of sulfur component, triethylene glycol and tetraethylene glycol was detected in the polyester resin.

### Comparative Example 9

Into a polycondensation reactor heated to 280° C., a heat-melted esterified product A was fed, and antimony (Sb) trioxide in an amount of 2.3×10⁻⁴ mol/mol acid component was added thereto to perform an etherification reaction at 280° C. for 60 minutes under normal pressure. While maintaining the temperature of the reactor at 280° C., the pressure of the system was gradually reduced to 0.5 hPa or less after 60 minutes. A polycondensation reaction was performed for 2 hours while stirring under the conditions to obtain a polyester resin. None of sulfur component, triethylene glycol and tetraethylene glycol was detected in the polyester resin.

### Comparative Example 10

Into a polycondensation reactor heated to 280° C., a heat-melted esterified product A (100 parts by mass) and an esterified product B (113 parts by mass) were fed, and antimony (Sb) trioxide in an amount of 2.0×10⁻⁴ mol/mol acid component was added thereto. Without etherification reaction, while maintaining the temperature of the reactor, the pressure of the system was gradually reduced to 0.5 hPa or less after 60 minutes. A polycondensation reaction was performed for 3 hours while stirring under the conditions to obtain a polyester resin. The polyester resin contained no sulfur component, with triethylene glycol in amount of 0.1 mol %.

### Comparative Example 11

Into a polycondensation reactor heated to 260° C., a heat-melted esterified product A (100 parts by mass), terephthalic acid (5.3 parts by mass), and 1,4-cyclohexanedimethanol (4.6 parts by mass) were fed, and heating and mixing were performed for 1 hour in a nitrogen atmosphere at 0.05 MPa. Subsequently, after raising the temperature of the reactor to 280° C., germanium (Ge) dioxide in an amount of 2.5×10⁻⁴ mol/mol acid component was added thereto, and the pressure of the system was gradually reduced to 0.5 hPa or less after 60 minutes without etherification reaction. A polycondensation reaction was performed for 2 hours while stirring under the conditions to obtain a copolymerized polyester resin. None of sulfur component, triethylene glycol and tetraethylene glycol was detected in the copolymerized polyester resin.

### Comparative Example 12

Into a polycondensation reactor heated to 260° C., a heat-melted esterified product A (100 parts by mass), terephthalic acid (4.4 parts by mass), and neopentyl glycol (2.8 parts by mass) were fed, and heating and mixing were performed for 1 hour in a nitrogen atmosphere at 0.05 MPa. Subsequently, after raising the temperature of the reactor to 280° C., germanium (Ge) dioxide in an amount of 2.5×10⁻⁴ mol/mol acid component was added. Without etherification reaction, the pressure of the system was gradually reduced to 0.5 hPa or less after 60 minutes. While stirring under the conditions, a polycondensation reaction was performed for 3 hours to obtain a copolymerized polyester resin. None of sulfur component, triethylene glycol and tetraethylene glycol was detected in the copolymerized polyester resin.

### Comparative Example 13

Into a polycondensation reactor heated to 260° C., a heat-melted esterified product A (100 parts by mass), terephthalic acid (4.4 parts by mass), and 3-methyl-1,5-pentanediol (2.4 parts by mass) were fed, and heating and mixing were performed for 1 hour in a nitrogen atmosphere at 0.05 MPa. Subsequently, after raising the temperature of the reactor to 280° C., germanium (Ge) dioxide in an amount of 2.5×10⁻⁴ mol/mol acid component was added thereto. Without etherification reaction, the pressure of the system was gradually reduced to 0.5 hPa or less after 60 minutes. A polycondensation reaction was performed for 3 hours while stirring under the conditions to obtain a copolymerized polyester resin. None of sulfur component, triethylene glycol and tetraethylene glycol was detected in the copolymerized polyester resin.

### Comparative Example 14

Into a polycondensation reactor heated to 260° C., a heat-melted esterified product A (100 parts by mass), terephthalic acid (5.8 parts by mass), and an ethylene oxide adduct of bisphenol A (11.1 parts by mass) were fed, and heating and mixing were performed for 1 hour in a nitrogen atmosphere at 0.05 MPa. Subsequently, after raising the temperature of the reactor to 280° C., antimony (Sb) trioxide in an amount of 2.0×10⁻⁴ mol/mol acid component was added. Without etherification reaction, the pressure of the system was gradually reduced to 0.5 hPa or less after 60 minutes. A polycondensation reaction was performed for 3 hours while stirring under the conditions to obtain a copolymerized polyester resin. None of sulfur component, triethylene glycol and tetraethylene glycol was detected in the copolymerized polyester resin.

### Comparative Example 15

A copolymerized polyester resin was obtained by the same operation as in Comparative Example 14, except that the amount of terephthalic acid was changed to 2.2 parts by mass, the amount of isophthalic acid was changed to 3.6 parts by mass, and the amount of the ethylene oxide adduct of bisphenol A was changed to 11.1 parts by mass. None of sulfur component, triethylene glycol and tetraethylene glycol was detected in the copolymerized polyester resin.

### Comparative Example 16

Into a polycondensation reactor heated to 260° C., a heat-melted esterified product A (100 parts by mass), terephthalic acid (27.9 parts by mass), and 1,4-butylene glycol (15.1 parts by mass) were fed, and heating and mixing were performed for 2 hours in a nitrogen atmosphere at 0.05 MPa. Subsequently, tetra-n-butyl titanate (Ti) in an amount of 4.0×10⁻¹ mol/mol acid component was added thereto. Without ten minute etherification reaction under normal pressure, the pressure of the system was gradually reduced to 0.5 hPa or less after 60 minutes. A polycondensation reaction was performed for 3 hours while stirring under the conditions to obtain a copolymerized polyester resin. None of sulfur component, triethylene glycol and tetraethylene glycol was detected in the copolymerized polyester resin.

### Comparative Example 17

A copolymerized polyester resin was obtained by the same operation as in Comparative Example 16, except that the amount of terephthalic acid was changed to 83.6 parts by mass, the amount of 1,4-butylene glycol was changed to 45.4 parts by mass, and the heating and mixing time was changed to 4 hours. None of sulfur component, triethylene glycol and tetraethylene glycol was detected in the copolymerized polyester resin.

### Comparative Example 18

Into a polycondensation reactor heated at 260° C., a heat-melted esterified product A (100 parts by mass), terephthalic acid (133.8 parts by mass), ε-caprolactone (9.1 parts by mass) and 1,4-butylene glycol (72.6 parts by mass) were fed, and heating and mixing were performed for 5 hours in a nitrogen atmosphere at 0.05 MPa. Subsequently, tetra-n-butyl titanate (Ti) in an amount of 4.0×10⁻⁴ mol/mol acid component was added thereto. Without etherification reaction, while maintaining the temperature, the pressure of the system was gradually reduced to 0.5 hPa or less after 60 minutes. A polycondensation reaction was performed for 3 hours while stirring under the conditions to obtain a copolymerized polyester resin. None of sulfur component, triethylene glycol and tetraethylene glycol was detected in the copolymerized polyester resin.

### Comparative Example 19

A copolymerized polyester resin was obtained by the same operation as in Comparative Example 18, except that the amount of terephthalic acid was changed to 98.4 parts by mass, the amount of ε-caprolactone was changed to 24.1 parts by mass, and the amount of 1,4-butylene glycol was changed to 53.4 parts by mass. None of sulfur component, triethylene glycol and tetraethylene glycol was detected in the copolymerized polyester resin.

### Comparative Example 20

A copolymerized polyester resin was obtained by the same operation as in Comparative Example 19, except that the amount of terephthalic acid was changed to 167.2 parts by mass, the amount of ε-caprolactone was changed to 31.5 parts by mass, and the amount of 1,4-butylene glycol was changed to 90.7 parts by mass. None of sulfur component, triethylene glycol and tetraethylene glycol was detected in the copolymerized polyester resin.

The polyester resin obtained in each of Examples 1 to 8 was dried and crystallized by a conventional method, and then fed into an extruder type spinning machine, extruded from a nozzle having 36 holes with a diameter of 0.2 mm at a spinning temperature of 290° C., cooled, and then wound at a rate of 1400 m/min. The resulting undrawn thread was drawn at a roller temperature of 80° C. and a heat setting temperature of 150° C. to obtain long fiber of 56 dtex/36 filaments.

Further, the polyester resin obtained in each of Examples 1 to 8 was dried and crystallized by a conventional method, and then fed into an extruder type film forming machine having a die slit width of 150 mm by 0.5 m. A film was formed at a film forming temperature of 290° C. and a winding roll temperature of 30° C. at a rate of about 2 m/min so as to have a film thickness of 0.2 mm, and wound. The resulting unstretched film was set in a batch type stretching apparatus and stretched 4.0 by 4.0 times in the MD and TD directions at 80° C. to obtain a film.

In Tables 1 to 3, the polymerization conditions, resin compositions, resin properties, and molded body evaluation of the polyester resins obtained in Examples 1 to 20 and Comparative Examples 1 to 10 are shown. In Tables 4 to 7, the polymerization conditions, resin compositions, resin properties, and molded body evaluation of the polyester resins obtained in Examples 21 to 36 and Comparative Examples 11 to 20 are shown.

TABLE 1

| | | | Example | | | | | | | | |
|---|---|---|---|---|---|---|---|---|---|---|---|
| | | | 1 | 2 | 3 | 4 | 5 | 6 | 7 | 8 | 9 |
| Polymerization | Proportions of | Esterified product A | 100 | 100 | 100 | 100 | 100 | 100 | 100 | 100 | 100 |
| condition | raw materials | Esterified product B | — | — | — | — | — | — | — | — | — |
| | charged (parts | EG | — | — | — | — | — | — | — | — | — |
| | by mass) | G/A (molar ratio) | 1.11 | 1.11 | 1.11 | 1.11 | 1.11 | 1.11 | 1.11 | 1.11 | 1.11 |
| | Catalyst | Type | OSB | SS | o-ABS | m-ABS | p-ABS | p-TSMe | SS | SS | SS |
| | | Amount added (×10⁻⁴ mol) | 2.0 | 2.0 | 2.0 | 2.0 | 2.0 | 2.0 | 2.0 | 2.0 | 2.0 |
| | Etherification | Temperature (° C.) | 280 | 280 | 280 | 280 | 280 | 280 | 250 | 250 | 250 |
| | reaction | Time (min) | 10 | 10 | 10 | 10 | 10 | 10 | 60 | 120 | 180 |
| Resin | Dicarboxylic | TPA | 100.0 | 100.0 | 100.0 | 100.0 | 100.0 | 100.0 | 100.0 | 100.0 | 100.0 |
| composition | acid component | IPA | — | — | — | — | — | — | — | — | — |
| (mol %) | Glycol | EG | 89.3 | 90.0 | 88.5 | 91.2 | 90.1 | 94.7 | 88.6 | 87.3 | 84.3 |
| | component | Di-EG | 9.9 | 9.2 | 10.6 | 8.1 | 9.1 | 5.1 | 10.3 | 11.5 | 13.9 |
| | | Tri-EG | 0.8 | 0.8 | 0.9 | 0.7 | 0.8 | 0.2 | 1.1 | 1.2 | 1.8 |
| | | Tetra-EG | — | — | — | — | — | — | — | — | — |
| | Metal component content (ppm) | | 0 | 0 | 0 | 0 | 0 | 0 | 0 | 0 | 0 |
| | Sulfur component content (ppm) | | 12 | 32 | 1 | 29 | 4 | 26 | 12 | 12 | 21 |
| Polyester resin properties | | [η] | 0.71 | 0.73 | 0.66 | 0.68 | 0.67 | 0.79 | 0.67 | 0.67 | 0.45 |
| | | Tg (° C.) | 72.0 | 72.1 | 70.0 | 72.0 | 71.2 | 75.5 | 70.2 | 69.0 | 68.1 |
| | | Tm (° C.) | 241.0 | 242.7 | 234.0 | 238.5 | 236.2 | 245.9 | 234.2 | 232.7 | 230.2 |
| Evaluation of | Tensile | Yield strength (MPa) | 51 | 48 | 52 | 49 | 55 | 60 | 58 | 59 | 60 |
| molded body | properties | Yield elongation (%) | 3.6 | 3.5 | 3.7 | 3.5 | 3.8 | 3.7 | 3.6 | 3.8 | 3.8 |
| | | Rupture strength (MPa) | — | — | — | — | — | — | — | — | — |
| | | Rupture elongation (%) | >200 | >200 | >200 | >200 | >200 | >200 | >200 | >200 | >200 |
| | | Elastic modulus (GPa) | 2.3 | 2.2 | 2.4 | 2.3 | 2.3 | 2.5 | 2.2 | 2.1 | 2.0 |

| | | | | | | | | | |
|---|---|---|---|---|---|---|---|---|---|
| Haze (%) | 0.3 | 0.3 | 0.4 | 0.3 | 0.3 | 0.3 | 0.3 | 0.4 | 0.3 |

TABLE 2

| | | | Example | | | | | |
|---|---|---|---|---|---|---|---|---|
| | | | 10 | 11 | 12 | 13 | 14 | 15 |
| Polymerization | Proportions of | Esterified product A | 100 | 100 | 100 | 100 | 100 | 100 |
| condition | raw materials | Esterified product B | — | — | — | — | 19 | 30 |
| | charged (parts | EG | 6 | 6 | 12 | 62 | — | — |
| | by mass) | G/A (molar ratio) | 1.31 | 1.31 | 1.51 | 3.11 | 1.33 | 1.44 |
| | Catalyst | Type | SS | SS | SS | SS | SS | SS |
| | | Amount added (×10⁻⁴ mol) | 2.0 | 2.0 | 2.0 | 2.0 | 2.0 | 2.0 |
| | Etherification | Temperature (° C.) | 250 | 250 | 250 | 250 | 260 | 260 |
| | reaction | Time (min) | 30 | 60 | 60 | 60 | 10 | 10 |
| Resin | Dicarboxylic | TPA | 100.0 | 100.0 | 100.0 | 100.0 | 89.8 | 84.5 |
| composition | acid component | IPA | — | — | — | — | 10.2 | 15.5 |
| (mol %) | Glycol | EG | 79.7 | 76.9 | 72.6 | 65.8 | 85.9 | 82.5 |
| | component | Di-EG | 17.4 | 19.5 | 24.4 | 28.9 | 12.4 | 15.5 |
| | | Tri-EG | 2.8 | 3.4 | 2.8 | 5.3 | 1.6 | 2.0 |
| | | Tetra-EG | 0.1 | 0.2 | 0.2 | 0.4 | 0.1 | 0.1 |
| | Metal component content (ppm) | | 0 | 0 | 0 | 0 | 0 | 0 |
| | Sulfur component content (ppm) | | 12 | 15 | 14 | 25 | 10 | 10 |
| Polyester resin properties | | [η] | 0.75 | 0.72 | 0.77 | 0.41 | 0.71 | 0.71 |
| | | Tg (° C.) | 63.2 | 61.0 | 53.0 | 48.2 | 64.1 | 61.5 |
| | | Tm (° C.) | 218.0 | 213.9 | 194.9 | — | 203.3 | — |
| Evaluation of | Tensile | Yield strength (MPa) | 49 | 53 | 55 | 58 | 57 | 61 |
| molded body | properties | Yield elongation (%) | 3.9 | 3.8 | 3.9 | 3.8 | 3.6 | 3.5 |
| | | Rupture strength (MPa) | — | — | — | — | 52 | 46 |
| | | Rupture elongation (%) | >200 | >200 | >200 | >200 | 192 | 191 |
| | | Elastic modulus (GPa) | 2.0 | 2.0 | 2.0 | 1.9 | 2.5 | 2.6 |

| | | | | | | |
|---|---|---|---|---|---|---|
| Haze (%) | 0.2 | 0.3 | 0.3 | 0.3 | 0.2 | 0.3 |

| | | | Example | | | | |
|---|---|---|---|---|---|---|---|
| | | | 16 | 17 | 18 | 19 | 20 |
| Polymerization | Proportions of | Esterified product A | 100 | 100 | 100 | 100 | 100 |
| condition | raw materials | Esterified product B | 42 | 56 | 72 | 91 | 113 |
| | charged (parts | EG | — | — | — | — | — |
| | by mass) | G/A (molar ratio) | 1.55 | 1.67 | 1.78 | 1.89 | 2.00 |
| | Catalyst | Type | SS | SS | SS | SS | SS |
| | | Amount added (×10⁻⁴ mol) | 2.0 | 2.0 | 2.0 | 2.0 | 2.0 |
| | Etherification | Temperature (° C.) | 260 | 260 | 260 | 260 | 260 |
| | reaction | Time (min) | 10 | 10 | 10 | 10 | 10 |
| Resin | Dicarboxylic | TPA | 80.2 | 74.5 | 69.4 | 64.5 | 60.2 |
| composition | acid component | IPA | 19.8 | 25.5 | 30.6 | 35.5 | 39.8 |
| (mol %) | Glycol | EG | 81.6 | 80.4 | 78.0 | 75.2 | 76.8 |
| | component | Di-EG | 16.3 | 17.2 | 18.9 | 20.9 | 19.9 |
| | | Tri-EG | 1.9 | 2.2 | 2.9 | 3.6 | 3.1 |
| | | Tetra-EG | 0.2 | 0.2 | 0.2 | 0.3 | 0.2 |
| | Metal component content (ppm) | | 0 | 0 | 0 | 0 | 0 |
| | Sulfur component content (ppm) | | 14 | 14 | 15 | 15 | 10 |
| Polyester resin properties | | [η] | 0.62 | 0.56 | 0.71 | 0.83 | 0.62 |
| | | Tg (° C.) | 60.8 | 57.5 | 56.3 | 53.9 | 53.2 |
| | | Tm (° C.) | — | — | — | — | — |
| Evaluation of | Tensile | Yield strength (MPa) | 55 | 63 | 66 | 60 | 50 |
| molded body | properties | Yield elongation (%) | 3.4 | 3.5 | 3.5 | 3.5 | 3.5 |
| | | Rupture strength (MPa) | — | 40 | 38 | 39 | — |
| | | Rupture elongation (%) | >200 | 184 | 187 | 173 | >200 |
| | | Elastic modulus (GPa) | 2.5 | 2.8 | 2.8 | 2.8 | 2.5 |

| | | | | | |
|---|---|---|---|---|---|
| Haze (%) | 0.4 | 0.4 | 0.4 | 0.4 | 0.3 |

TABLE 3

| | | | Comparative Example | | | | | | | | | |
|---|---|---|---|---|---|---|---|---|---|---|---|---|
| | | | 1 | 2 | 3 | 4 | 5 | 6 | 7 | 8 | 9 | 10 |
| Polymerization | Proportions of | Esterified product A | 100 | 100 | 100 | 100 | 100 | 100 | 100 | 100 | 100 | 100 |
| condition | raw materials | Esterified product B | — | — | — | — | — | 42 | 113 | — | — | 113 |
| | charged (parts | EG | — | — | 12 | — | — | — | — | — | — | — |
| | by mass) | G/A (molar ratio) | 1.11 | 1.11 | 1.51 | 1.11 | 1.03 | 1.55 | 2.00 | 1.11 | 1.11 | 2.00 |
| | Catalyst | Type | OSB | SS | SS | SS | SS | SS | SS | Sb | Sb | Sb |
| | | Amount added | 2.0 | 2.0 | 2.0 | 2.0 | 2.0 | 2.0 | 2.0 | 2.3 | 2.3 | 2.0 |
| | | (×10⁻⁴ mol) | | | | | | | | | | |
| | Etherification | Temperature (° C.) | — | — | — | 230 | 280 | — | — | — | 280 | — |
| | reaction | Time (min) | — | — | — | 10 | 10 | — | — | — | 60 | — |
| Resin | Dicarboxylic | TPA | 100.0 | 100.0 | 100.0 | 100.0 | 100.0 | 80.1 | 59.9 | 100.0 | 100.0 | 60.4 |
| composition | acid component | IPA | — | — | — | — | | 19.9 | 40.1 | — | — | 39.6 |
| (mol %) | Glycol | EG | 95.9 | 96.7 | 95.9 | 96.5 | 98.3 | 95.8 | 94.0 | 98.5 | 98.6 | 94.0 |
| | component | Di-EG | 4.1 | 3.3 | 4.0 | 3.5 | 1.7 | 4.1 | 5.9 | 1.5 | 1.4 | 5.9 |
| | | Tri-EG | — | — | 0.1 | — | — | 0.1 | 0.1 | — | — | 0.1 |
| | | Tetra-EG | — | — | — | — | — | — | — | — | — | — |
| | Metal component content (ppm) | | 0 | 0 | 0 | 0 | 0 | 0 | 0 | 15 | 14 | 13 |
| | Sulfur component content (ppm) | | 10 | 15 | 13 | 17 | 30 | 20 | 19 | 0 | 0 | 0 |
| Polyester resin properties | | [η] | 0.72 | 0.70 | 0.74 | 0.69 | 0.69 | 0.65 | 0.60 | 0.73 | 0.70 | 0.61 |
| | | Tg (° C.) | 77.6 | 77.9 | 76.9 | 77.8 | 79.5 | 61.0 | 64.2 | 79.7 | 79.7 | 65.0 |
| | | Tm (° C.) | 248.9 | 249.2 | 248.1 | 249.3 | 252.3 | — | — | 252.4 | 252.5 | — |
| Evaluation of | Tensile | Yield strength | 52 | 54 | 52 | 51 | 51 | 62 | 64 | 49 | 50 | 63 |
| molded body | properties | (MPa) | | | | | | | | | | |
| | | Yield elongation | 4.0 | 4.1 | 3.8 | 4.0 | 4.0 | 4.3 | 4.2 | 3.5 | 3.5 | 4.3 |
| | | (%) | | | | | | | | | | |
| | | Rupture strength | 27.0 | 25.5 | 24.7 | 25.0 | 25.4 | 37.0 | 32.0 | 26.0 | 27.1 | 35.1 |
| | | (MPa) | | | | | | | | | | |
| | | Rupture elongation | 164 | 152 | 157 | 149 | 148 | 81 | 49 | 185 | 179 | 52 |
| | | (%) | | | | | | | | | | |
| | | Elastic modulus | 2.5 | 2.2 | 2.2 | 2.2 | 2.2 | 2.4 | 2.7 | 2.3 | 2.3 | 2.7 |
| | | (GPa) | | | | | | | | | | |

| | | | | | | | | | | |
|---|---|---|---|---|---|---|---|---|---|---|
| Haze (%) | 0.4 | 0.5 | 0.4 | 0.4 | 0.4 | 0.4 | 0.4 | 3.7 | 3.8 | 4.1 |

TABLE 4

| | | | Example | | | | | |
|---|---|---|---|---|---|---|---|---|
| | | | 21 | 22 | 23 | 24 | 25 | 26 |
| Polymerization | Proportions of | Esterified product A | 100.0 | 100.0 | 100.0 | 100.0 | 100.0 | 100.0 |
| condition | raw materials | TPA | 5.3 | 9.3 | 5.8 | 14.8 | — | 2.2 |
| | charged (parts | IPA | — | — | — | — | 3.5 | 3.6 |
| | by mass) | EG | — | — | — | — | 0.7 | — |
| | | CHDM | 4.6 | 8.1 | — | — | — | — |
| | | BAEO | — | — | 11.1 | 28.1 | 3.3 | 11.1 |
| | | NPG | — | — | — | — | — | — |
| | | MPD | — | — | — | — | — | — |
| | | BD | — | — | — | — | — | — |
| | | ε-CL | — | — | — | — | — | — |
| | | G/A (molar ratio) | 1.11 | 1.11 | 1.11 | 1.11 | 1.11 | 1.11 |
| | Catalyst | Type | SS | SS | SS | SS | SS | SS |
| | | Amount added (×10⁻⁴ mol) | 2.0 | 2.0 | 2.0 | 2.0 | 2.0 | 2.0 |
| | Etherification | Temperature (° C.) | 280 | 280 | 280 | 280 | 280 | 280 |
| | reaction | Time (min) | 10 | 10 | 10 | 10 | 10 | 10 |
| Resin | Dicarboxylic | TPA | 100.0 | 100.0 | 100.0 | 100.0 | 96.1 | 95.9 |
| composition | acid component | IPA | — | — | — | — | 3.9 | 4.1 |
| (mol %) | Glycol | EG | 84.1 | 79.4 | 84.0 | 76.2 | 87.3 | 83.5 |
| | component | Di-EG | 9.3 | 8.9 | 9.0 | 8.1 | 9.7 | 9.2 |
| | | Tri-EG | 0.7 | 0.7 | 0.6 | 0.6 | 0.8 | 0.6 |
| | | CHDM | 5.9 | 11.0 | — | — | — | — |
| | | BAEO | — | — | 6.4 | 15.1 | 2.2 | 6.7 |
| | | NPG | — | — | — | — | — | — |
| | | MPD | — | — | — | — | — | — |
| | | BD | — | — | — | — | — | — |
| | Lactam component | ε-CL | — | — | — | — | — | — |
| | Metal component content (ppm) | | 0 | 0 | 0 | 0 | 0 | 0 |
| | Sulfur component content (ppm) | | 16 | 18 | 14 | 15 | 8 | 12 |
| Polyester resin properties | | [η] | 0.68 | 0.69 | 0.64 | 0.64 | 0.63 | 0.72 |
| | | Tg (° C.) | 75.1 | 76.0 | 74.2 | 68.7 | 73.1 | 72.1 |
| | | Tm (° C.) | 224.1 | 222.3 | 225.2 | — | 228.7 | 210.7 |
| Evaluation of | Tensile | Yield strength (MPa) | 50.1 | 48.3 | 50.2 | 55.2 | 49.6 | 50.0 |
| molded body | properties | Yield elongation (%) | 4.3 | 4.1 | 4.2 | 4.1 | 4.1 | 4.0 |
| | | Rupture strength (MPa) | — | 33 | — | — | — | — |
| | | Rupture elongation (%) | >200 | 187 | >200 | >200 | >200 | >200 |
| | | Elastic modulus (GPa) | 2.3 | 2.2 | 2.4 | 2.4 | 2.3 | 2.4 |

| | | | | | | |
|---|---|---|---|---|---|---|
| Haze (%) | 0.3 | 0.3 | 0.4 | 0.2 | 0.2 | 0.3 |

TABLE 5

| | | | Example | | | | | |
|---|---|---|---|---|---|---|---|---|
| | | | 27 | 28 | 29 | 30 | 31 | 32 |
| Polymerization | Proportions of | Esterified product A | 100.0 | 100.0 | 100.0 | 100.0 | 100.0 | 100.0 |
| condition | raw materials | TPA | 4.4 | 14.8 | 4.4 | 9.3 | 4.4 | 27.9 |
| | charged (parts | IPA | — | — | — | — | — | — |
| | by mass) | EG | — | — | — | — | — | — |
| | | CHDM | — | — | — | — | — | — |
| | | BAEO | — | — | — | — | — | — |
| | | NPG | 2.8 | 9.2 | — | — | — | — |
| | | MPD | — | — | 2.4 | 5.0 | — | — |
| | | BD | — | — | — | — | 2.4 | 15.1 |
| | | ε-CL | — | — | — | — | — | — |
| | | G/A (molar ratio) | 1.11 | 1.11 | 1.11 | 1.11 | 1.11 | 1.11 |
| | Catalyst | Type | SS | SS | SS | SS | SS | SS |
| | | Amount added (×10⁻⁴ mol) | 2.0 | 2.0 | 2.0 | 2.0 | 2.0 | 2.0 |
| | Etherification | Temperature (° C.) | 280 | 280 | 280 | 280 | 260 | 260 |
| | reaction | Time (min) | 10 | 10 | 10 | 10 | 10 | 10 |
| Resin | Dicarboxylic | TPA | 100.0 | 100.0 | 100.0 | 100.0 | 100.0 | 100.0 |
| composition | acid component | IPA | — | — | — | — | — | — |
| (mol %) | Glycol | EG | 85.3 | 76.6 | 85.6 | 80.6 | 85.3 | 66.9 |
| | component | Di-EG | 9.1 | 8.2 | 8.9 | 8.8 | 9.0 | 7.4 |
| | | Tri-EG | 0.6 | 0.5 | 0.6 | 0.5 | 0.6 | 0.5 |
| | | CHDM | — | — | — | — | — | — |
| | | BAEO | — | — | — | — | — | — |
| | | NPG | 5.0 | 14.7 | — | — | — | — |
| | | MPD | — | — | 4.9 | 10.1 | — | — |
| | | BD | — | — | — | — | 5.1 | 25.2 |
| | Lactam component | ε-CL | — | — | — | — | — | — |
| | Metal component content (ppm) | | 0 | 0 | 0 | 0 | 0 | 0 |
| | Sulfur component content (ppm) | | 11 | 16 | 19 | 9 | 17 | 18 |
| Polyester resin properties | | [η] | 0.68 | 0.64 | 0.63 | 0.65 | 0.61 | 0.64 |
| | | Tg (° C.) | 74.9 | 69.8 | 73.3 | 70.1 | 72.8 | 60.2 |
| | | Tm (° C.) | 223.9 | — | 224.5 | 219.0 | 222.1 | 201.4 |
| Evaluation of | Tensile | Yield strength (MPa) | 50.6 | 50.2 | 49.9 | 50.8 | 49.4 | 43.2 |
| molded body | properties | Yield elongation (%) | 3.8 | 3.8 | 3.9 | 4.2 | 3.8 | 3.4 |
| | | Rupture strength (MPa) | — | — | — | — | 41 | 38 |
| | | Rupture elongation (%) | >200 | >200 | >200 | >200 | 151 | 98.0 |
| | | Elastic modulus (GPa) | 2.1 | 2.1 | 2.2 | 2.1 | 2.1 | 1.9 |

| | | | | | | |
|---|---|---|---|---|---|---|
| Haze (%) | 0.3 | 0.3 | 0.2 | 0.2 | 0.4 | 0.3 |

TABLE 6

| | | | Example | | | | Comparative Example | | |
|---|---|---|---|---|---|---|---|---|---|
| | | | 33 | 34 | 35 | 36 | 11 | 12 | 13 |
| Polymerization | Proportions of | Esterified product A | 100.0 | 100.0 | 100.0 | 100.0 | 100.0 | 100.0 | 100.0 |
| condition | raw materials | TPA | 83.6 | 133.8 | 98.4 | 167.2 | 5.3 | 4.4 | 4.4 |
| | charged (parts | IPA | — | — | — | — | — | — | — |
| | by mass) | EG | — | — | — | — | — | — | — |
| | | CHDM | — | — | — | — | 4.6 | — | — |
| | | BAEO | — | — | — | — | — | — | — |
| | | NPG | — | — | — | — | — | 2.8 | — |
| | | MPD | — | — | — | — | — | — | 2.4 |
| | | BD | 45.4 | 72.6 | 53.4 | 90.7 | — | — | — |
| | | ε-CL | — | 9.1 | 24.1 | 31.5 | — | — | — |
| | | G/A (molar ratio) | 1.11 | 1.11 | 1.11 | 1.11 | 1.11 | 1.11 | 1.11 |
| | Catalyst | Type | SS | SS | SS | SS | Ge | Ge | Ge |
| | | Amount added (×10⁻⁴ mol) | 2.0 | 2.0 | 2.0 | 2.0 | 2.5 | 2.5 | 2.5 |
| | Etherification | Temperature (° C.) | 260 | 260 | 260 | 260 | — | — | — |
| | reaction | Time (min) | 10 | 10 | 10 | 10 | — | — | — |
| Resin | Dicarboxylic | TPA | 100.0 | 97.6 | 92.4 | 92.5 | 100.0 | 100.0 | 100.0 |
| composition | acid component | IPA | — | — | — | — | — | — | — |
| (mol %) | Glycol | EG | 44.3 | 33.2 | 37.2 | 24.5 | 91.4 | 93.1 | 92.9 |
| | component | Di-EG | 5.1 | 4.0 | 3.9 | 2.8 | 2.5 | 1.8 | 1.9 |
| | | Tri-EG | 0.3 | 0.2 | 0.3 | 0.2 | — | — | — |
| | | CHDM | — | — | — | — | 6.1 | — | — |
| | | BAEO | — | — | — | — | — | — | — |
| | | NPG | — | — | — | — | — | 5.1 | — |
| | | MPD | — | — | — | — | — | — | 5.2 |
| | | BD | 50.3 | 60.2 | 51.0 | 65.0 | — | — | — |
| | Lactam component | ε-CL | — | 4.9 | 15.3 | 15.0 | — | — | — |
| | Metal component content (ppm) | | 0 | 0 | 0 | 0 | 21 | 25 | 23 |
| | Sulfur component content (ppm) | | 14 | 23 | 14 | 27 | 0 | 0 | 0 |
| Polyester resin properties | | [η] | 0.63 | 0.65 | 0.71 | 0.71 | 0.68 | 0.70 | 0.69 |
| | | Tg(° C.) | 47.1 | 48.0 | 42.8 | 27.3 | 77.0 | 77.2 | 75.3 |
| | | Tm(° C.) | 177.8 | 176.1 | 175.5 | 159.0 | 230.0 | 230.3 | 234.1 |
| Evaluation of | Tensile | Yield strength (MPa) | 41.1 | 40.6 | 40.2 | 40.3 | 50.1 | 51.0 | 51.3 |
| molded body | properties | Yield elongation (%) | 3.0 | 3.1 | 3.0 | 3.0 | 4.0 | 3.7 | 4.2 |
| | | Rupture strength (MPa) | 31 | 33 | 34 | 31 | 34 | 27 | 28 |
| | | Rupture elongation (%) | 80.9 | 82.2 | 81.1 | 80.2 | 184.1 | 175.1 | 180.2 |
| | | Elastic modulus (GPa) | 1.9 | 1.9 | 1.7 | 1.7 | 2.3 | 2.1 | 2.2 |

| | | | | | | | |
|---|---|---|---|---|---|---|---|
| Haze (%) | 0.3 | 0.4 | 0.4 | 0.3 | 0.7 | 0.7 | 0.6 |

TABLE 7

| | | | Comparative Example | | | | | | |
|---|---|---|---|---|---|---|---|---|---|
| | | | 14 | 15 | 16 | 17 | 18 | 19 | 20 |
| Polymerization | Proportions of | Esterified product A | 100.0 | 100.0 | 100.0 | 100.0 | 100.0 | 100.0 | 100.0 |
| condition | raw materials | TPA | 5.8 | 2.2 | 27.9 | 83.6 | 133.8 | 98.4 | 167.2 |
| | charged (parts | IPA | — | 3.6 | — | — | — | — | — |
| | by mass) | EG | — | — | — | — | — | — | — |
| | | CHDM | — | — | — | — | — | — | — |
| | | BAEO | 11.1 | 11.1 | — | — | — | — | — |
| | | NPG | — | — | — | — | — | — | — |
| | | MPD | — | — | — | — | — | — | — |
| | | BD | — | — | 15.1 | 45.4 | 72.6 | 53.4 | 90.7 |
| | | ε-CL | — | — | — | — | 9.1 | 24.1 | 31.5 |
| | | G/A (molar ratio) | 1.11 | 1.11 | 1.11 | 1.11 | 1.11 | 1.11 | 1.11 |
| | Catalyst | Type | Sb | Sb | Ti | Ti | Ti | Ti | Ti |
| | | Amount added (×10⁻⁴ mol) | 2.0 | 2.0 | 4.0 | 4.0 | 4.0 | 4.0 | 4.0 |
| | Etherification | Temperature (° C.) | — | — | — | — | — | — | — |
| | reaction | Time (min) | — | — | — | — | — | — | — |
| Resin | Dicarboxylic | TPA | 100.0 | 95.8 | 100.0 | 100.0 | 97.5 | 92.4 | 92.5 |
| composition | acid component | IPA | — | 4.2 | — | — | — | — | — |
| (mol %) | Glycol | EG | 91.1 | 91.2 | 73.5 | 48.6 | 36.7 | 41.9 | 26.9 |
| | component | Di-EG | 2.4 | 2.2 | 1.5 | 1.0 | 0.7 | 0.6 | 0.3 |
| | | Tri-EG | — | — | — | — | — | — | — |
| | | CHDM | — | — | — | — | — | — | — |
| | | BAEO | 6.5 | 6.6 | — | — | — | — | — |
| | | NPG | — | — | — | — | — | — | — |
| | | MPD | — | — | — | — | — | — | — |
| | | BD | — | — | 25.0 | 50.4 | 60.1 | 49.9 | 65.3 |
| | Lactam component | ε-CL | — | — | — | — | 5.1 | 15.2 | 15.1 |
| | Metal component content (ppm) | | 18 | 19 | 33 | 40 | 42 | 37 | 47 |
| | Sulfur component content (ppm) | | 0 | 0 | 0 | 0 | 0 | 0 | 0 |
| Polyester resin properties | | [η] | 0.66 | 0.67 | 0.64 | 0.67 | 0.65 | 0.70 | 0.69 |
| | | Tg (° C.) | 78.0 | 76.5 | 64.7 | 50.2 | 51.8 | 45.2 | 28.8 |
| | | Tm (° C.) | 233.0 | 216.7 | 206.4 | 181.0 | 178.2 | 179.3 | 160.2 |
| Evaluation of | Tensile | Yield strength (MPa) | 48.1 | 49.9 | 44.3 | 40.0 | 40.1 | 41.3 | 40.6 |
| molded body | properties | Yield elongation (%) | 4.0 | 3.9 | 3.1 | 2.5 | 2.6 | 2.5 | 2.2 |
| | | Rupture strength (MPa) | 33 | 35 | 40 | 32 | 39 | 37 | 31 |
| | | Rupture elongation (%) | 175.0 | 169.3 | 60.1 | 49.4 | 51.0 | 47.0 | 46.0 |
| | | Elastic modulus (GPa) | 2.4 | 2.4 | 2.0 | 1.9 | 1.9 | 1.8 | 1.9 |

| | | | | | | | |
|---|---|---|---|---|---|---|---|
| Haze (%) | 3.9 | 4.0 | 4.3 | 4.2 | 4.4 | 4.4 | 4.3 |

The polyester resins of the present invention obtained in Examples 1 to 36 were excellent in various performances when formed into a molded body.

In Comparative Examples 1 to 3 and 6 to 7, no etherification reaction was performed, in Comparative Example 4, the temperature of the etherification reaction was low, and in Comparative Example 5, the etherification reaction was performed using raw materials having a low molar ratio between the glycol component (G) and the acid component (A), i.e. (G/A), so that none of the resulting polyester resins satisfied the range of triethylene glycol content specified in the present invention, which resulted in low rapture elongation of the molded body.

In Comparative Examples 8 to 10 and 14 to 20, the polyester resin was produced by using a metal-based catalyst (antimony catalyst or titanium catalyst) as catalyst instead of an organic sulfonic acid-based compound, so that any of the resulting molded body had poor in haze. In Comparative Examples 11 to 13, although the polyester resin produced by using a germanium-based catalyst was excellent in haze, the molded body had a low rapture elongation because the content of triethylene glycol did not satisfy the range specified in the present invention.

1. A polyester resin comprising a dicarboxylic acid component and a glycol component,
wherein the glycol component contains ethylene glycol together with diethylene glycol and triethylene glycol, and
a content of triethylene glycol in the glycol component is more than 0.1 mol % and 5.5 mol % or less.

2. The polyester resin according to claim 1,
wherein a content of diethylene glycol in the glycol component is 2.5 mol % or more.

3. The polyester resin according to claim 1,
wherein the glycol component contains tetraethylene glycol, and a content of tetraethylene glycol in the glycol component is 2.0 mol % or less.

4. The polyester resin according to claim 3,
wherein a sum of the content of triethylene glycol and the content of tetraethylene glycol in the glycol component is 7.0 mol % or less.

5. The polyester resin according to claim 1, wherein a content of a metal component derived from catalyst is 1 ppm or less.

6. The polyester resin according to claim 1, wherein a content of a sulfur component is 1 to 500 ppm.

7. The polyester resin according to claim 1, wherein the dicarboxylic acid component comprises terephthalic acid as a main component.

8. The polyester resin according to claim 1, wherein a molded body thereof having a thickness of 2 mm has a haze of 5% or less.

9. A molded body comprising the polyester resin according to claim 1.

10. A fiber comprising the polyester resin according to claim 1.

11. A film comprising the polyester resin according to claim 1.

12. An adhesive comprising the polyester resin according to claim 1.

13. A resin solution comprising the polyester resin according to claim 1 and a solvent.

14. A method for producing the polyester resin according to claim 1, comprising
adding an organic sulfonic acid-based compound to a raw material polyester resin, and heating the mixture at a temperature of 240° C. or more under normal pressure or increased pressure for 5 to 120 minutes to perform an etherification reaction of the glycol component.

15. The method for producing a polyester resin according to claim 14, wherein the organic sulfonic acid-based compound is at least one or more selected from the group consisting of 2-sulfobenzoic acid anhydride, o-sulfobenzoic acid, m-sulfobenzoic acid, p-sulfobenzoic acid, 5-sulfosalicylic acid, benzenesulfonic acid, o-aminobenzenesulfonic acid, m-aminobenzenesulfonic acid, p-aminobenzenesulfonic acid, p-toluenesulfonic acid, methyl p-toluenesulfonate, 5-sulfoisophthalic acid, and salts thereof.
